(19) United States
(12) Patent Application Publication
(10) Pub. No.: US 2005/0239540 A1
(43) Pub. Date: Oct. 27, 2005

(54) Gaming machine

(75) Inventor: Yukinori Inamura, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE CORP.

(21) Appl. No.: 11/113,015

(22) Filed: Apr. 25, 2005

(30) Foreign Application Priority Data
Apr. 27, 2004 (JP) 2004-131973

(51) Int. Cl. A63F 13/00

(52) U.S. Cl. 463/20

(57) ABSTRACT

A gaming machine on which the player can freely set an activated pay line is provided. The game player may identify the pay line by touching any of stop areas for display five times via a touch panel (S101: YES) such that the player can choose the activated pay line (S102-S110). Therefore, the player can freely set the activated pay line with any combinations. Also, after such identified pay line is determined whether it can be set or not (S103: YES), it is set as the activated pay line (S110) and a prescribed gaming characteristics may be retained.

### CROSS-REFERENCE TO RELATED APPLICATIONS

This application is based upon and claims the benefits of priority from Japanese Patent Application No. 2004-131973 filed on Apr. 27, 2004, the entire contents of which are incorporated herein by reference.

### FIELD OF THE INVENTION

The present invention relates to a gaming machine utilizing an activated pay line for a game.

### RELATED ART

Conventionally, a gaming machine such as a slot machine has a plurality of reels rotating for a predetermined period of time and is configured that a payout such as coins is accomplished according to a combination of symbols appearing in a state that each reel is stopped (e.g., JP-A-07-313659). In this respect, the combination of symbols for the payout such as coins is a combination of symbols appearing on one of predetermined pay lines among many pay lines.

In this respect, the predetermined pay line is selected from many pay lines having been determined such that a game player's desire cannot reflect on an activated pay line for actually paying out.

### SUMMARY OF THE INVENTION

Now, in view of the above, it is an object to enable the game player to set freely the activated pay line with any combination of symbols.

There is provided a gaming machine (e.g., slot machine 1) having a display device (e.g., a lower LCD 4) and a game control means (e.g., CPU 50) for paying a payout based on a combination of symbols appearing on one or more activated pay lines on said display device, comprising: a plurality of stop areas for display (e.g., stop areas 211-213, 221-223, 231-233, 241-243, 251-253) for display, which constitutes said activated pay line and on which one of said symbols appears; a plurality of selection buttons (e.g., a group of touch button 141) corresponding to the plurality of stop areas (e.g., stop areas 211-213, 221-223, 231-233, 241-243, 251-253), respectively; a determination means (e.g., CPU 50) for determining whether a line comprising the plurality of stop areas (e.g., stop areas 211-213, 221-223, 231-233, 241-243, 251-253) identified via said plurality of selection buttons (e.g., a group of touch button 141) is activated as said activated pay line or not; and a setting means (e.g., CPU 50) for setting said line as said activated pay line, said line being determined to be activated.

According to the present invention, since the activated pay line can be set by identifying the pay line via the plurality of selection buttons corresponding to respective stop areas for display which constitute the activated pay line in the gaming machine, the game player may freely set his activated pay line such that the amusement of the game is enhanced.

Also, the identified pay line on this occasion is set after it is determined whether the identified pay line can be set such that gaming characteristics may be retained with the gaming machine since the payout amount is based on a combination of symbols appearing on the activated pay line.

More specifically, the following is provided.

(1) A gaming machine having a display device and game control means for providing a payout based on a symbol arrangement on said display device, the gaming machine comprising: a plurality of stop areas for display, on which a plurality of symbols are variably displayed and stopped to form said symbol arrangement, said symbol arrangement comprising at least one symbol appearing in an area arrangement being composed of at least one of said plurality of stop areas; a plurality of selection buttons corresponding to said plurality of stop areas, respectively; determination means for determining whether said area arrangement having been identified via said plurality of selection buttons can be activated or not; and setting means for setting said area arrangement being activated.

The symbol arrangement may span one or more display areas such that symbols appearing in the one or more display areas (or in the area arrangement) respectively constitute a symbol arrangement (including a symbol combination), which may be determined to be a wining combination for a payout or another benefit such as obtaining a chance to play a bonus game. In other words, the sybol arrangment may appear in the respective area arrangement such that the the area arrangement may comprise one or more display areas. The area arrangment may correspond to one or more stop display areas (or display areas) such that a single stop display area may be an area arrangement and a plurality of stop display areas may form another area arrangement while the plurality of stop display areas are located next to each other or located separately (in a scattered manner).

(2) The gaming machine according to (1), wherein said game control means provides a payout based on at least one appearing symbol in at least one of said plurality of stop areas regardless of said area arrangement.

(3) The gaming machine according to (1) or (2), wherein said display device comprises a touch panel that identifies said area arrangement therethrough. Identification of area arrangement can also be carried out by mechanical buttons on the control panel.

(4) The gaming machine according to any from (1) to (3), wherein said area arrangement comprises a pay line.

(5) A gaming machine comprising: a cabinet; a display device provided on a front face of the cabinet; a plurality of selection buttons provided on the cabinet; and a game controller provided- inside the cabinet for controlling a game, wherein the display device comprises a plurality of stop areas for variably displaying symbols, said plurality of stop area can be identified by said plurality of selection buttons, respectively, and a symbol arrangement comprises at least one symbol being stopped and appearing in at least one of said plurality of stop areas such that said symbol arrangement corresponds to an area arrangement being composed of the at least one of said plurality of stop areas; and wherein said game controller controls the game such that the gaming machine provides a payout based on said symbol arrangement appearing in said area arrangement after determining whether said area arrangement having been located via said plurality of selection buttons can be activated or not.

(6) The gaming machine according to (5), wherein said game controller controls the gaming machine so as to provide a payout based on at least one appearing symbol in at least one of said plurality of stop areas regardless of said area arrangement.

(7) The gaming machine according to (5) or (6), wherein said display device comprises a touch panel such that said area arrangement is identified therethrough.

(8) The gaming machine according to any one from (5) to (7), wherein said area arrangement comprises a pay line.

(9) A method of controlling a game with the gaming machine as defined in (2) or (6), comprising: making a player select said area arrangement; starting a lottery; determining if a bonus game is won; and starting a bonus game when the bonus game is won.

Further features of the present invention, its nature, and various advantages will be more apparent from the accompanying drawings and the following description of the preferred embodiment.

### BRIEF DESCRIPTION OF THE DRAWINGS

FIG. 1 is a flowchart of an activated line selection processing program;

FIG. 2 is a perspective view of a slot machine;

FIG. 3 is a front view of a control table;

FIG. 4 is a block diagram schematically showing a control system for the slot machine;

FIG. 5 is a block diagram schematically showing a liquid crystal driver circuit of a lower liquid crystal display;

FIGS. 6A-6E are explanatory diagrams schematically showing columns of symbols, the displays of which are varied in the variable display windows in a normal game;

FIG. 7 is a diagram showing one symbol to be included in a symbol column;

FIG. 8 is an explanatory diagram showing winning combinations and payouts thereof;

FIG. 9 is an explanatory diagram showing a lottery table of appearing symbols;

FIG. 10 is a diagram showing stop areas for display of five variable display windows;

FIG. 11 is a diagram showing a first pay line;

FIG. 12 is a diagram showing a second pay line;

FIG. 13 is a diagram showing a third pay line;

FIG. 14 is a diagram showing a fourth pay line;

FIG. 15 is a diagram showing a fifth pay line;

FIG. 16 is a diagram showing a sixth pay line;

FIG. 17 is a diagram showing a seventh pay line;

FIG. 18 is a diagram showing an eighth pay line;

FIG. 19 is a diagram showing a ninth pay line;

FIG. 20 is a diagram showing a tenth pay line;

FIG. 21 is a diagram showing an eleventh pay line;

FIG. 22 is a diagram showing a twelfth pay line;

FIG. 23 is a diagram showing a thirteenth pay line;

FIG. 24 is a diagram showing a fourteenth pay line;

FIG. 25 is a diagram showing a fifteenth pay line;

FIG. 26 is a diagram showing a sixteenth pay line;

FIG. 27 is a diagram showing a seventeenth pay line;

FIG. 28 is a diagram showing an eighteenth pay line;

FIG. 29 is a diagram showing a nineteenth pay line;

FIG. 30 is a diagram showing a twentieth pay line;

FIG. 31 is a diagram showing a twenty first pay line;

FIG. 32 is a diagram showing a twenty second pay line;

FIG. 33 is a diagram showing a twenty third pay line;

FIG. 34 is a diagram showing a twenty fourth pay line;

FIG. 35 is a diagram showing a twenty fifth pay line;

FIG. 36 is a flowchart of a ma in processing program;

FIG. 37 is a flowchart of a start reception processing program;

FIG. 38 is a flowchart of a lottery processing program;

FIG. 39 is a flowchart of a normal game processing program;

FIG. 40 is a flowchart of a free game processing program;

FIG. 41 is an explanatory diagram showing a lottery table of appearing symbols;

FIGS. 42A-42E are explanatory diagrams schematically showing columns of symbols varied in the variable display windows in a bonus game;

FIG. 43 is a diagram showing another pay line;

FIG. 44 is a diagram showing another pay line;

FIG. 45 is an explanatory diagram showing an example of a display indicating that the twenty fifth pay line is selected;

FIG. 46 is a flowchart of an activated line selection processing program; and

FIG. 47 is a diagram showing another pay line.

### DESCRIPTION OF THE PREFERRED EMBODIMENT

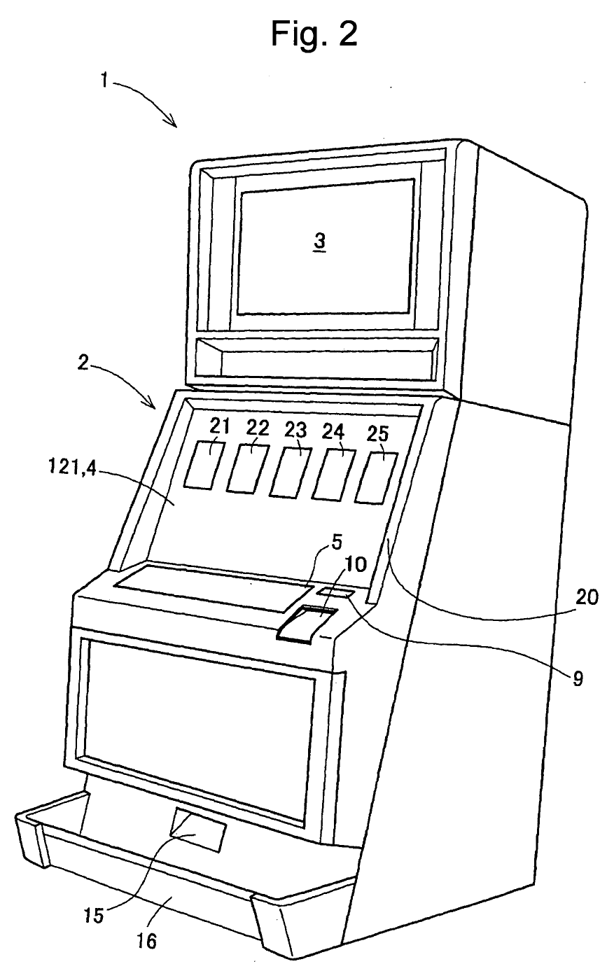

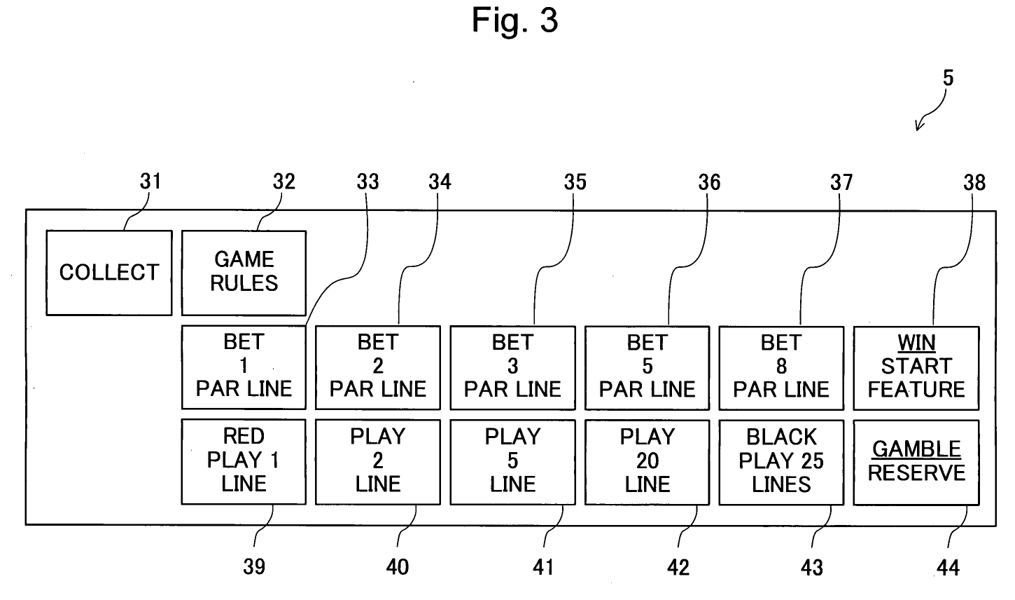

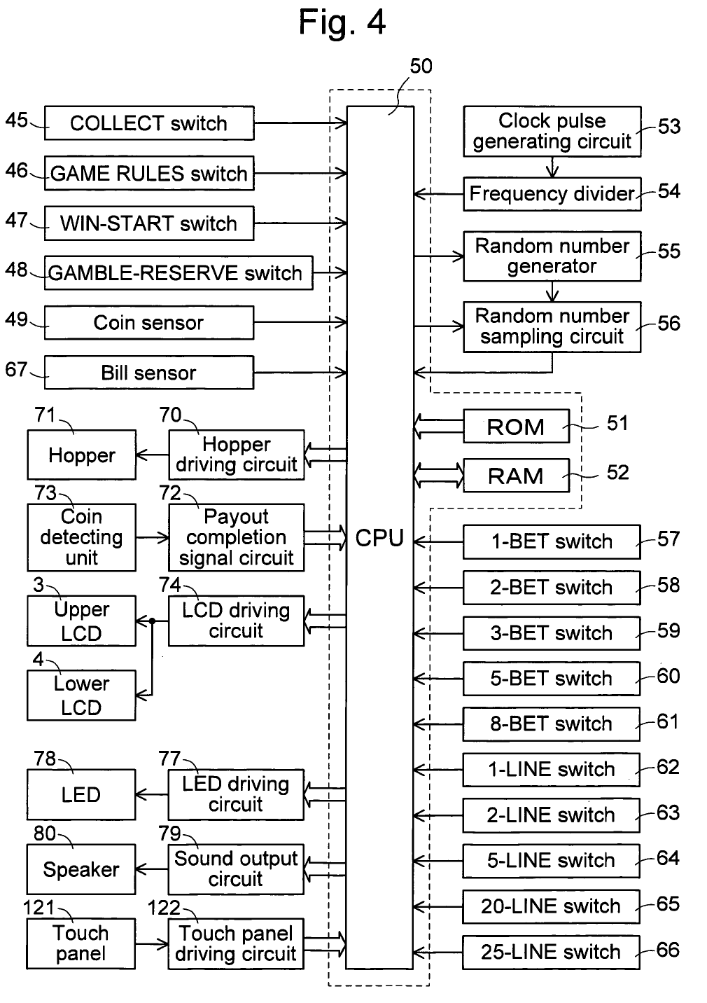

A gaming machine according to the present invention will be described in detail based on an embodiment of a slot machine with reference to the drawings. However, the present invention is not limited to the embodiment, and various modifications and changes in design can be made without departing from the scope of the present invention. First of all, the schematic construction of the slot machine according to this embodiment will be described with reference to FIGS. 2 to 4. FIG. 2 is a perspective view of the slot machine. FIG. 3 is a front view of a control table. FIG. 4 is a block diagram schematically showing a control system of the slot machine.

In FIG. 2, a slot machine 1 has a cabinet 2 forming the whole. An upper liquid crystal display 3 is placed in the upper front part of the cabinet 2, and a lower liquid crystal display 4 is placed on a machine front panel 20 placed at the front center part of the cabinet 2. Here, the liquid crystal display 3 includes a liquid crystal display of a generally-used display, and the lower liquid crystal display 4 is also includes a liquid crystal display of a generally-used display. The upper liquid crystal display 3 displays information on a game such as a game method, the kind of a winning combination and payout thereof and an effect relating to the game. The lower liquid crystal display 4 includes a touch panel 121 on the screen. Furthermore, the lower liquid crystal display 4 displays a credit value and displays five variable display windows 21, 22, 23, 24 and 25 basically as shown in FIG. 2. Different kinds of symbols, which will be described later, are stopped in the variable display windows 21 to 25 after the displays of the symbols are varied while being scrolled from the top to the bottom.

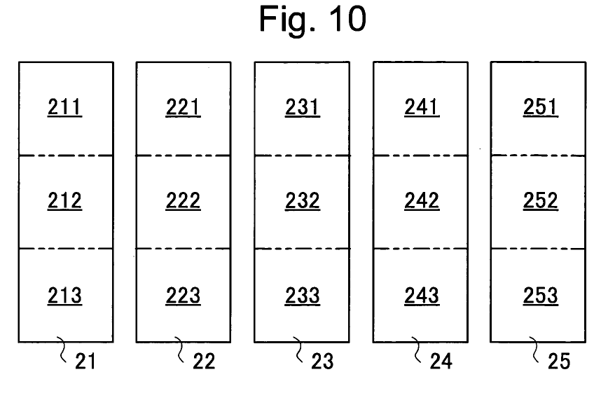

Therefore, in the slot machine 1 according to this embodiment, a slot game (including a normal game and a bonus game) is performed with video reels implemented by being displayed through the variable display windows 21 to 25 of the lower liquid crystal display 4. In the slot game (including a normal game and a bonus game), three symbols are stopped in each of the variable display windows 21 to 25. That is, as shown in FIG. 10, the variable display windows 21 to 25 are divided into first stop areas 211, 221, 231, 241 and 251, second stop areas 212, 222, 232, 242 and 252 and third stop areas 213, 223, 233, 243 and 253, and symbols are stopped in the stop areas 211 to 213, 221 to 223, 231 to 233, 241 to 243 and 251 to 253 for display.

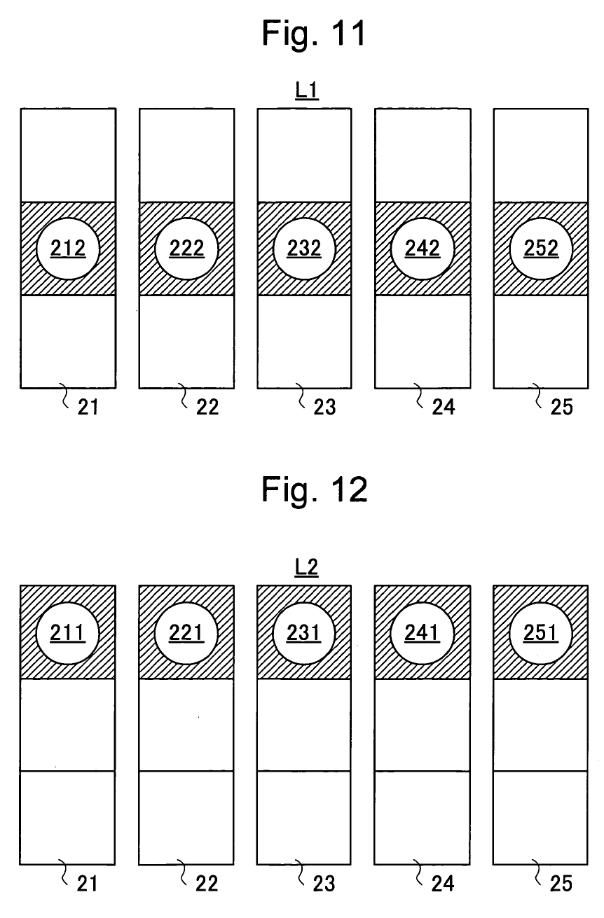

In the slot game (including a normal game and a bonus game), twenty five (25) pay lines are provided such that each pay line spans the stop areas 211 to 213, 221 to 223, 231 to 233, 241 to 243 and 251 to 253 for display and connects one of the first, second and third stop areas in each group (211 to 213, 221 to 223, 231 to 233, 241 to 243, or 251 to 253) of stop areas. When symbols are stopped to appear on an activated pay line to make a combination of specific kinds of symbols in a specific form, a payout is given. Now, the pay line will be described more specifically with reference to FIGS. 11 to 35. FIGS. 11 to 35 are diagrams each showing one pay line shaded.

That is, as indicated by the shaded parts in FIG. 11, a first pay line L1 spans the second stop areas 212, 222, 232, 242 and 252 for display.

As indicated by the shaded parts in FIG. 12, a second pay line L2 spans the first stop areas 211, 221, 231, 241 and 251 for display.

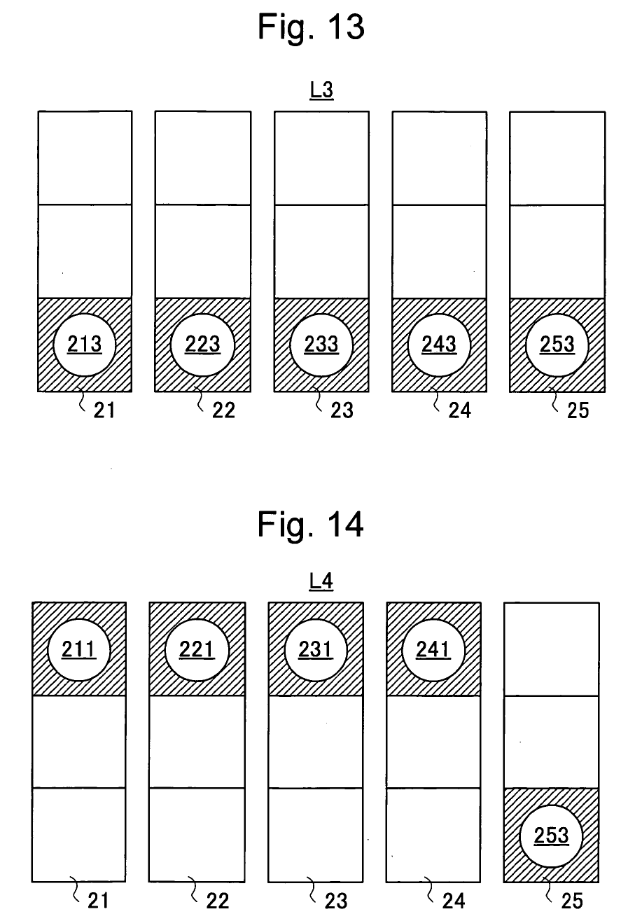

As indicated by the shaded parts in FIG. 13, a third pay line L3 spans the third stop areas 213, 223, 233, 243 and 253 for display.

As indicated by the shaded parts in FIG. 14, a fourth pay line L4 spans the first stop areas 211, 221, 231 and 241 for display and the third stop area 253 for display.

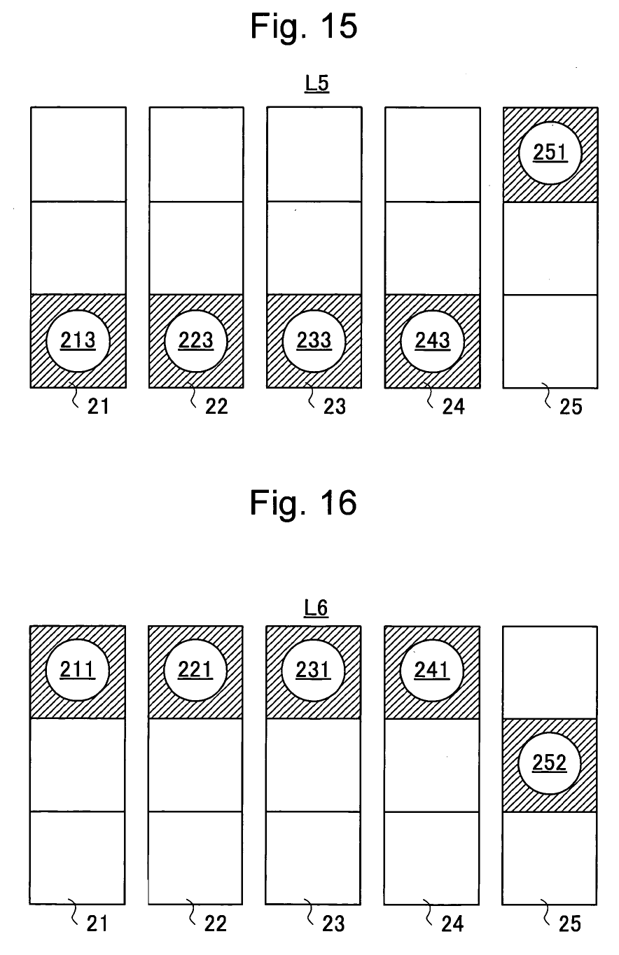

As indicated by the shaded parts in FIG. 15, a fifth pay line L5 spans the first stop area 251 for display and the third stop areas 213, 223, 233 and 243 for display.

As indicated by the shaded parts in FIG. 16, a sixth pay line L6 spans the first stop areas 211, 221, 231 and 241 for display and the second stop area 252 for display.

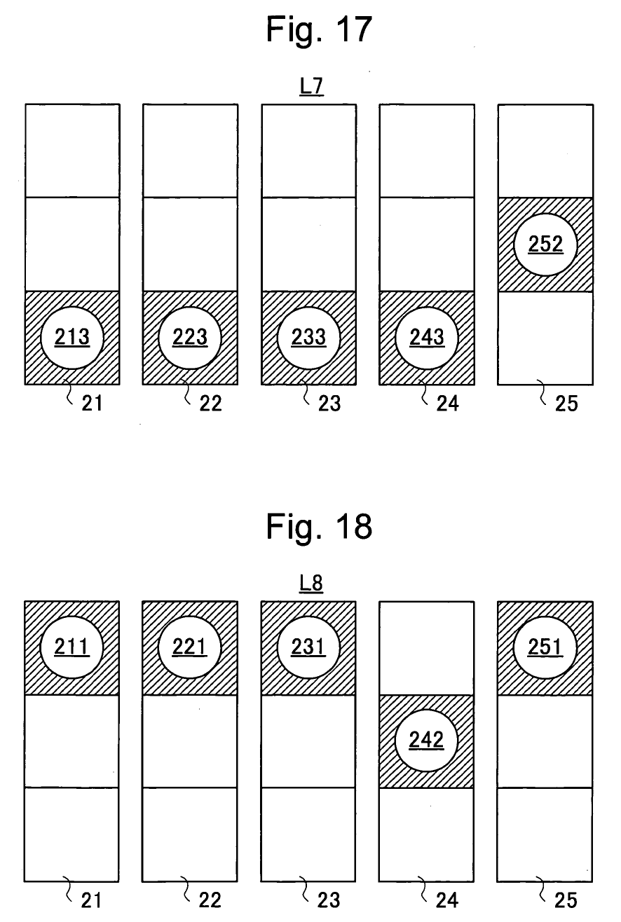

As indicated by the shaded parts in FIG. 17, a seventh pay line L7 spans the second stop area 252 for display and the third stop areas 213, 223, 233 and 243 for display.

As indicated by the shaded parts in FIG. 18, an eighth pay line L8 spans the first stop areas 211, 221, 231 and 251 for display and the second stop area 242 for display.

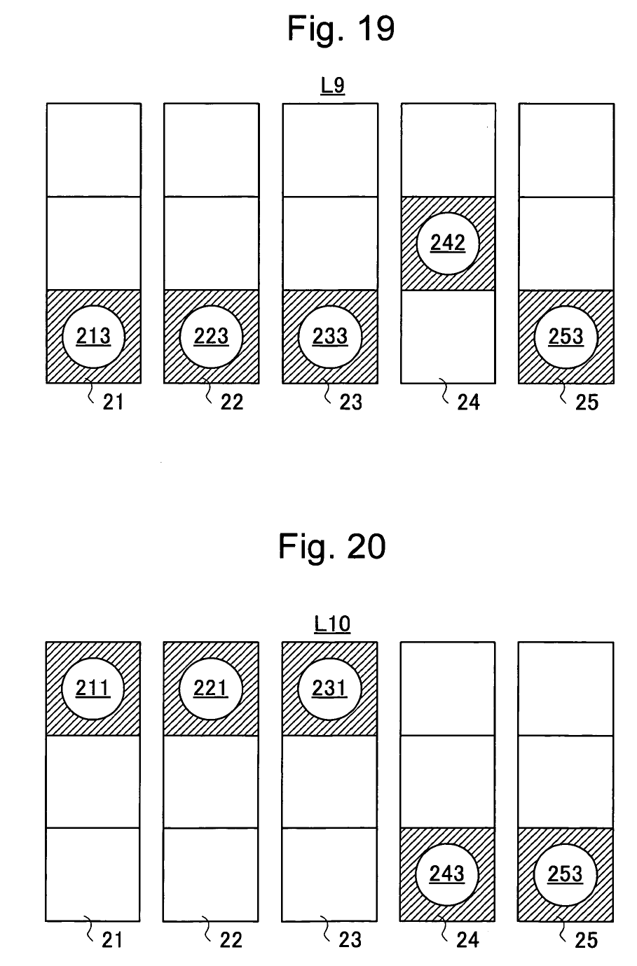

As indicated by the shaded parts in FIG. 19, a ninth pay line L9 spans the second stop area 242 for display and the third stop areas 213, 223, 233 and 253 for display.

As indicated by the shaded parts in FIG. 20, a tenth pay line L10 spans the first stop areas 211, 221 and 231 for display and the third stop areas 243 and 253 for display.

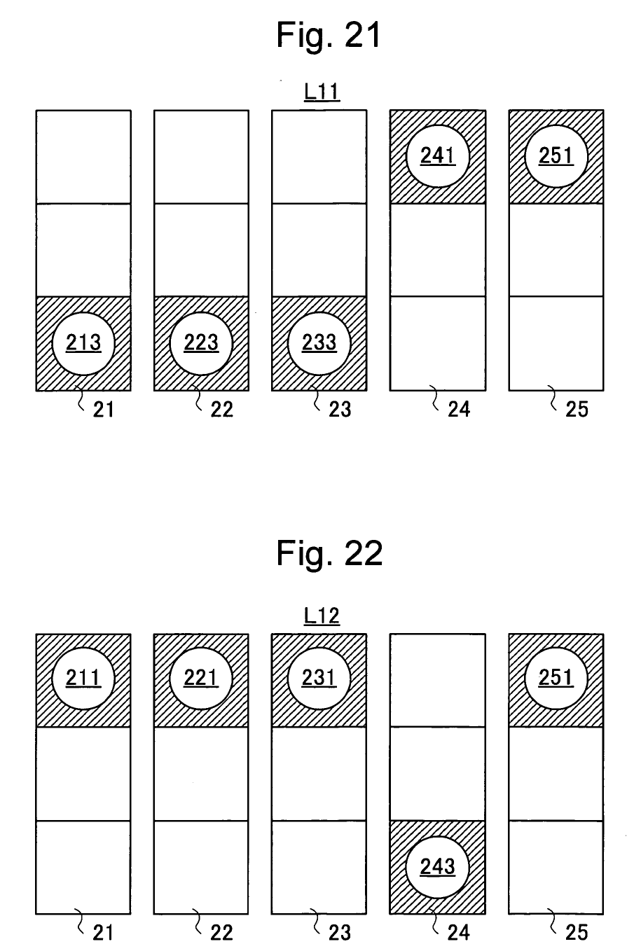

As indicated by the shaded parts in FIG. 21, an eleventh pay line L11 spans the first stop areas 241 and 251 for display and the third stop areas 213, 223 and 233 for display.

As indicated by the shaded parts in FIG. 22, a twelfth pay line L12 spans the first stop areas 211, 221, 231 and 251 for display and the third stop area 243 for display.

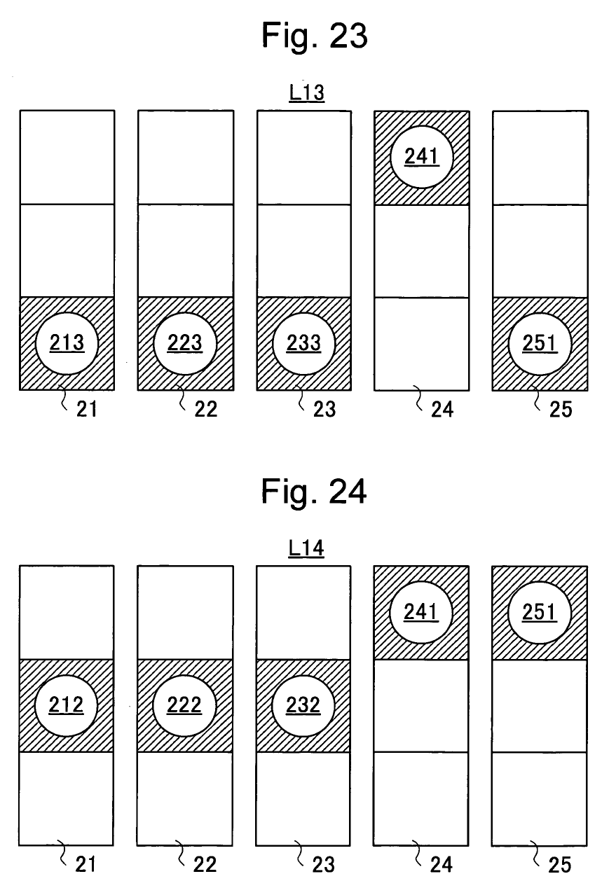

As indicated by the shaded parts in FIG. 23, a thirteenth pay line L13 spans the first stop area 241 for display and the third stop areas 213, 223, 233 and 253 for display.

As indicated by the shaded parts in FIG. 24, a fourteenth pay line L14 spans the first stop areas 241 and 251 for display and the second stop areas 212, 222 and 232 for display.

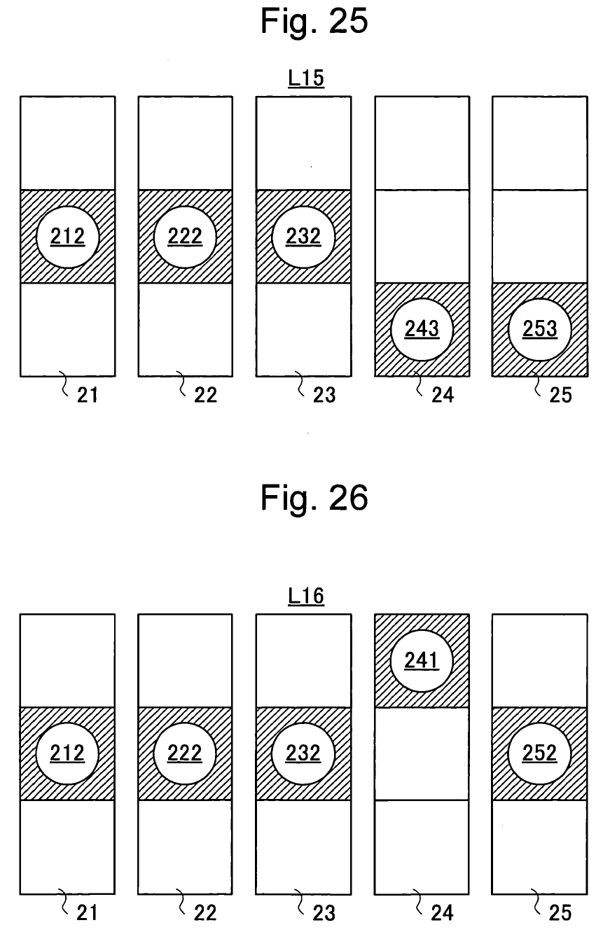

As indicated by the shaded parts in FIG. 25, a fifteenth pay line L15 spans the second stop areas 212, 222 and 232 for display and the third stop areas 243 and 253 for display.

As indicated by the shaded parts in FIG. 26, a sixteenth pay line L16 spans the first stop area 241 for display and the second stop areas 212, 222, 232 and 252 for display.

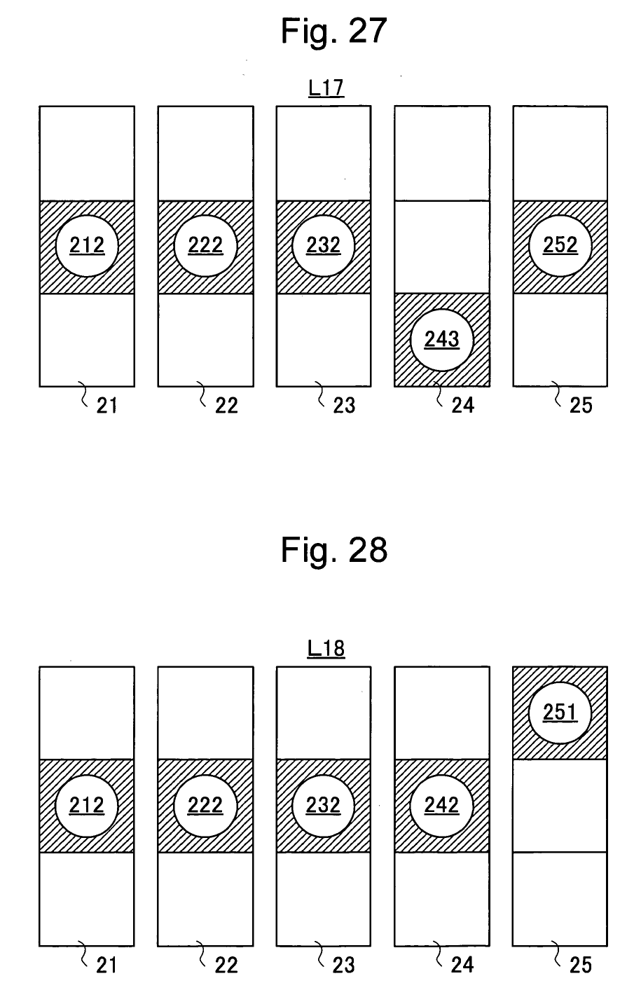

As indicated by the shaded parts in FIG. 27, a seventeenth pay line L17 spans the second stop areas 212, 222, 232 and 252 for display and the third stop area 243 for display.

As indicated by the shaded parts in FIG. 28, an eighteenth pay line L18 spans the first stop area 251 for display and the second stop areas 212, 222, 232 and 242 for display.

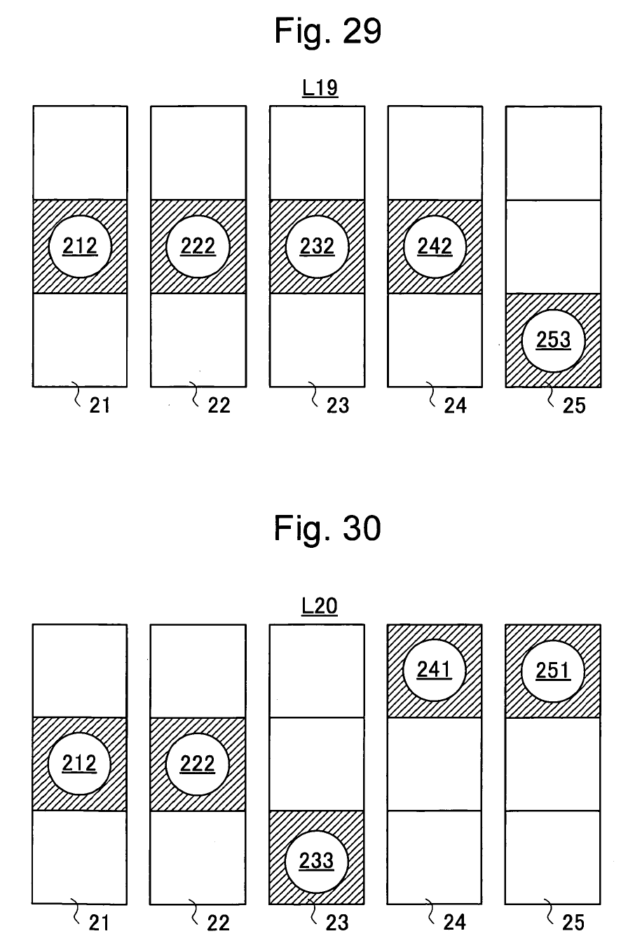

As indicated by the shaded parts in FIG. 29, a nineteenth pay line L19 spans the second stop areas 212, 222, 232 and 242 for display and the third stop area 253 for display.

As indicated by the shaded parts in FIG. 30, a twentieth pay line L20 spans the first stop areas 241 and 251 for display, the second stop areas 212 and 222 for display and the third stop area 233 for display.

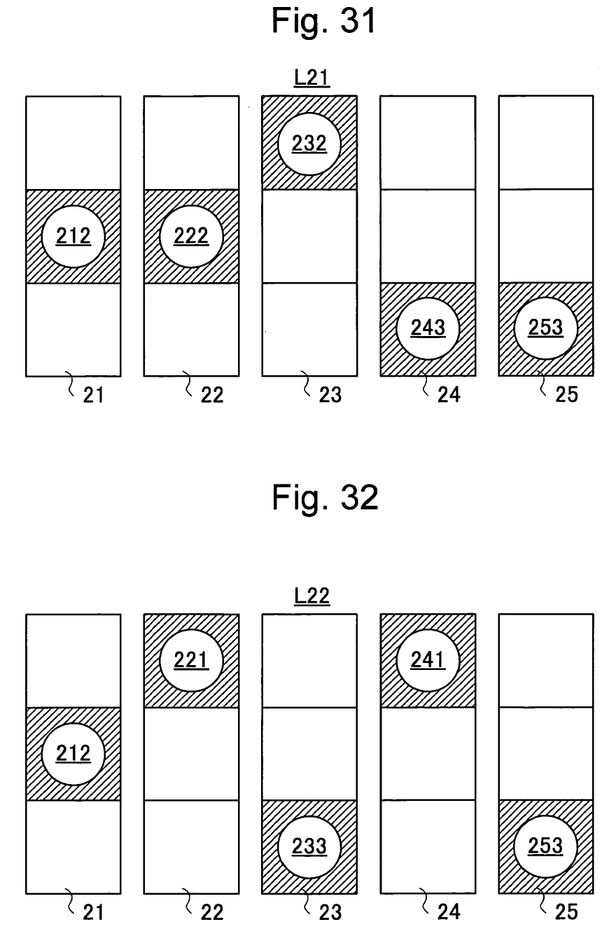

As indicated by the shaded parts in FIG. 31, a twenty first pay line L21 spans the first stop area 231 for display, the second stop areas 212 and 222 for display and the third stop areas 243 and 253 for display.

As indicated by the shaded parts in FIG. 32, a twenty second pay line L22 spans the first stop areas 221 and 241 for display, the second stop area 212 for display and the third stop areas 233 and 253 for display.

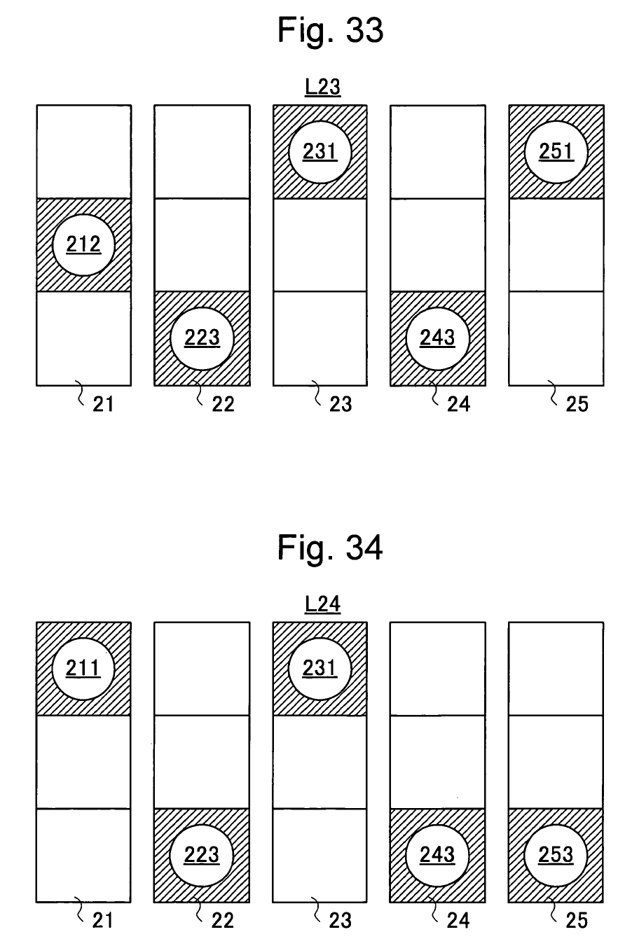

As indicated by the shaded parts in FIG. 33, a twenty third pay line L23 spans the first stop areas 231 and 251 for display, the second stop area 212 for display and the third stop areas 223 and 243 for display.

As indicated by the shaded parts in FIG. 34, a twenty fourth pay line L24 spans the first stop areas 211 and 231 for display and the third stop areas 223, 243 and 253 for display.

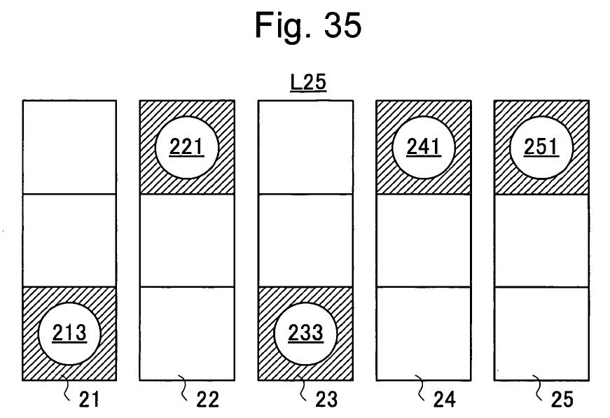

As indicated by the shaded parts in FIG. 35, a twenty fifth pay line L25 spans the first stop areas 221, 241 and 251 for display and the third stop areas 213 and 233 for display.

Notably, the expression, “activated pay line”, refers to a pay line, which is made activated, among 25 pay lines.

Referring back to FIG. 2, a control table 5 projecting to the proximal side is provided at the bottom of the lower liquid crystal display 4. As shown in FIG. 3, COLLECT button 31 and GAME RULES button 32 in order from the leftmost side are placed in the upper part of control table 5. BET 1 PER LINE button 33, BET 2 PER LINE button 34, BET 3 PER LINE button 35, BET 5 PER LINE button 36, BET 8 PER LINE button 37 and WIN START FEATURE button 38 in order from the leftmost side are placed in the middle part. RED PLAY 1 LINE button 39, PLAY 2 LINES button 40, PLAY 5 LINES button 41, PLAY 20 LINES button 42, BLACK PLAY 25 LINES button 43 and GAMBLE RESERVE button 44 in order from the leftmost side are placed in the lower part. As shown in FIG. 2, a coin insertion slot 9 and a paper money insertion slot (or bill insertion slot) 10 are provided on the right side of the control table 5.

COLLECT button 31 is a button to be pressed upon exit from a normal game. When COLLECT button 31 is pressed, the number of coins equivalent to the credit value having acquired in the game are paid out from a coin payout opening 15 to a coin tray 16. COLLECT button 31 is associated with COLLECT switch 45, and a switch signal is output to a CPU 50 based on COLLECT button 31 pressed (see FIG. 4). GAME RULES button 32 is a button to be pressed when how the game should be operated is not clear. When GAME RULES button 32 is pressed, help information is displayed on the upper liquid crystal display 3 and/or lower liquid crystal display 4. GAME RULES button 32 is associated with GAME RULES switch 46, and a switch signal from GAME RULES switch 46 is output to the CPU 50 based on GAME RULES button 32 pressed (see FIG. 4).

The coin insertion slot 9 has a coin sensor 49. When a coin or coins are inserted to the coin insertion slot 9, a coin detection signal is output to the CPU 50 through the coin sensor 49 (see FIG. 4), and the credit value equivalent to the number of inserted coins is added. The paper money insertion slot 10 has a paper money sensor (or bill sensor) 67. When paper money is inserted to the paper money insertion slot 10, a bill detection signal is output to the CPU 50 through the bill sensor 67 (see FIG. 4), and the credit value equivalent to the number of inserted bills is added.

BET 1 PER LINE button 33 is a button for betting 1 for each activated pay line every time pressed once. BET 1 PER LINE button 33 is associated with 1-BET switch 57. When BET 1 PER LINE button 33 is pressed, a switch signal is output from 1-BET switch 57 to the CPU 50 based on the pressed BET 1 PER LINE button 33 (see FIG. 4). BET 2 PER LINE button 34 is a button for starting a game with a BET value of 2 for each activated pay line as BET 2 PER LINE button 34 is pressed. BET 2 PER LINE button 34 is associated with 2-BET switch 58. When BET 2 PER LINE button 34 is pressed, a switch signal is output from 2-BET switch 58 to the CPU 50 based on the pressed BET 2 PER LINE button 34 (see FIG. 4).

BET 3 PER LINE button 35 is a button for starting a game with a BET value of 3 for each activated pay line based on the pressed BET 3 PER LINE button 35. BET 3 PER LINE button 35 is associated with 3-BET switch 59. When BET 3 PER LINE button 35 is pressed, a switch signal is output from 3-BET switch 59 to the CPU 50 based on the pressed BET 3 PER LINE button 35 (see FIG. 4). BET 5 PER LINE button 36 is a button for starting a game with a BET value of 5 for each activated pay line based on BET 5 PER LINE button 36 pressed. BET 5 PER LINE button 36 is associated with 5-BET switch 60. When BET 5 PER LINE button 36 is pressed, a switch signal is output from 5-BET switch 60 to the CPU 50 based on the pressed BET 5 PER LINE button 36 (see FIG. 4).

BET 8 PER LINE button 37 is a button for starting a game with a BET value of 8 for each activated pay line based on the pressed BET 8 PER LINE button 37. BET 8 PER LINE button 37 is associated with 8-BET switch 61. When BET 8 PER LINE button 37 is pressed, a switch signal is output from 8-BET switch 61 to the CPU 50 based on the pressed BET 8 PER LINE button 37 (see FIG. 4).

The BET values which can be bet by pressing BET 1 PER LINE button 33, BET 2 PER LINE button 34, BET 3 PER LINE button 35, BET 5 PER LINE button 36 and BET 8 PER LINE button 37 may be 1, 2, 3, 5 and 8.

WIN START FEATURE button 38 is a button for starting a bonus game or adding a payout amount having acquired in the bonus game to a credit value. WIN START FEATURE button 38 is associated with WIN-START switch 47. When WIN START FEATURE button 38 is pressed, a switch signal is output from WIN-START switch 47 to the CPU 50 (see FIG. 4).

RED PLAY 1 LINE button 39 is a button for starting a game with “1” activated pay line based on the pressed RED PLAY 1 LINE button 39. RED PLAY 1 LINE button 39 is associated with 1-LINE switch 62. A switch signal is output from 1-LINE switch 62 to the CPU 50 based on the pressed RED PLAY 1 LINE button 39 (see FIG. 4). PLAY 2 LINES button 40 is a button for starting a game with “2” activated pay lines based on the pressed PLAY 2 LINES button 40. PLAY 2 LINES button 40 is associated with 2-LINES switch 63. A switch signal is output from 2-LINES switch 63 to the CPU 50 based on the pressed PLAY 2 LINES button 40 (see FIG. 4).

PLAY 5 LINES button 41 is a button for starting a game with “5” activated pay lines based on the pressed PLAY 5 LINES button 41. PLAY 5 LINES button 41 is associated with 5-LINES switch 64. A switch signal is output from 5-LINES switch 64 to the CPU 50 based on the pressed PLAY 5 LINES button 41 (see FIG. 4). PLAY 20 LINES button 42 is a button for starting a game with “20” activated pay lines based on the pressed PLAY 20 LINES button 42 pressed. PLAY 20 LINES button 42 is associated with 20-LINES switch 65. A switch signal is output from 20-LINES switch 65 to the CPU 50 based on the pressed PLAY 20 LINES button 42 (see FIG. 4).

BLACK PLAY 25 LINES button 43 is a button for starting a game with “25” activated pay lines based on the pressed BLACK PLAY 25 LINES button 43. BLACK PLAY 25 LINES button 43 is associated with 25-LINES switch 66. A switch signal is output from 25-LINES switch 66 to the CPU 50 based on the pressed BLACK PLAY 25 LINES button 43 (see FIG. 4).

Therefore, the number of activated pay line or lines, which can be determined by pressing RED PLAY 1 LINE button 39, PLAY 2 LINES button 40, PLAY 5 LINES button 41, PLAY 20 LINES button 42 and BLACK PLAY 25 LINES button 43 may be “1”, “2”, “5”, “20” and “25”.

When RED PLAY 1 LINE button 39 is pressed, the pay line L1 shown in

FIG. 11 is made activated. When PLAY 2 LINES button 40 is pressed, the pay lines L1 and L2 shown in FIGS. 11 and 12 are made activated. When PLAY 5 LINES button 41 is pressed, the pay lines L1 to L5 shown in FIGS. 11 to 15 are made activated. When PLAY 20 LINES button 42 is pressed, the pay lines L1 to L20 shown in FIGS. 11 to 30 are made activated. When BLACK PLAY 25 LINES button 43 is pressed, the pay lines L1 to L25 shown in FIGS. 11 to 35 are made activated.

RED PLAY 1 LINE button 39, PLAY 2 LINES button 40, PLAY 5 LINES button 41, PLAY 20 LINES button 42 and BLACK PLAY 25 LINES button 43 are buttons for starting to display variably symbols in the variable display windows 21 to 25 of the lower liquid crystal display 4 so as to start a game with the current BET value and the number of activated pay lines based on those pressed buttons.

RED PLAY 1 LINE button 39 and BLACK PLAY 25 LINES button 43 are also used for selecting red or black in a double down game performed by utilizing the credit having been acquired in a bonus game.

GAMBLE RESERVE button 44 is a button to be pressed when a player leaves the sheet or for shifting to a double down game after exit from the bonus game. GAMBLE RESERVE button 44 is associated with GAMBLE-RESERVE switch 48, and a switch signal is output from GAMBLE-RESERVE switch 48 to the CPU 50 based on the pressed GAMBLE RESERVE button 44 (see FIG. 4).

The cabinet 2 has the coin payout opening 15 and coin tray 16 in the lower part. The coin tray 16 receives a coin paid out from the coin payout opening 15. A coin detecting unit 73, which will be described later, including a sensor is placed in the internal part of the coin payout opening 15 (see FIG. 4). The coin detecting unit 73 detects the number of coin or coins to be paid out from the coin payout opening 15.

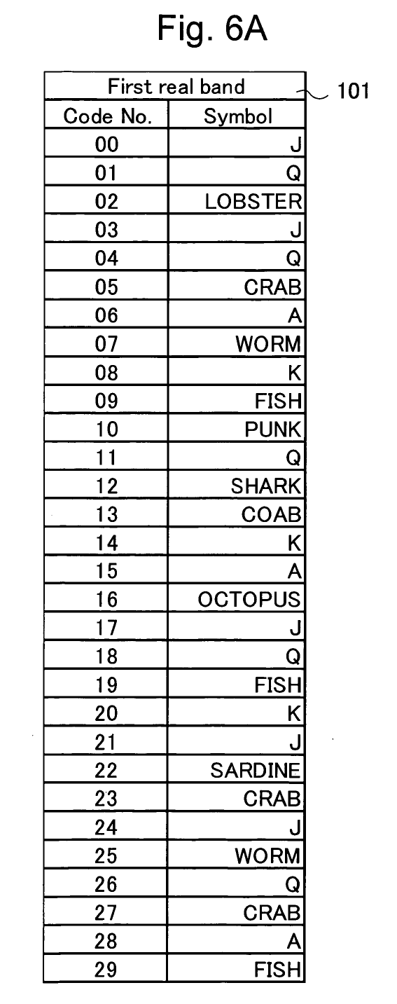

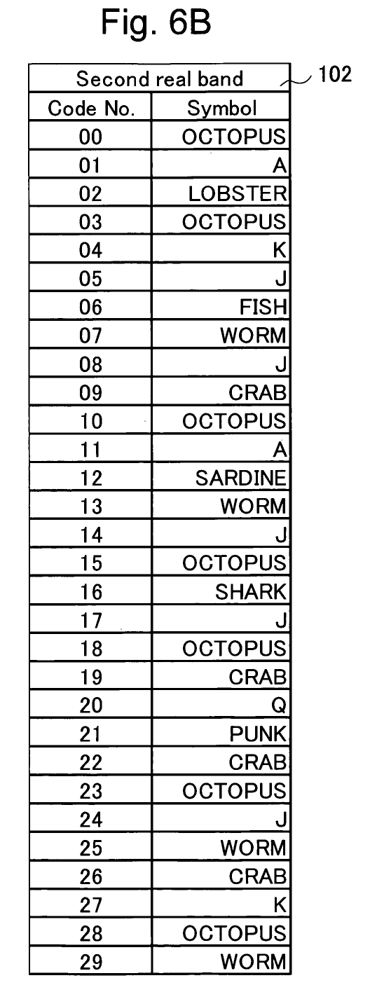

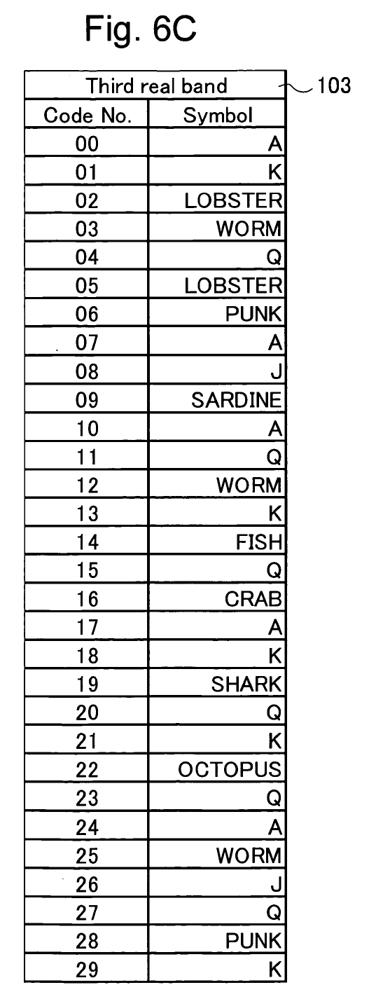

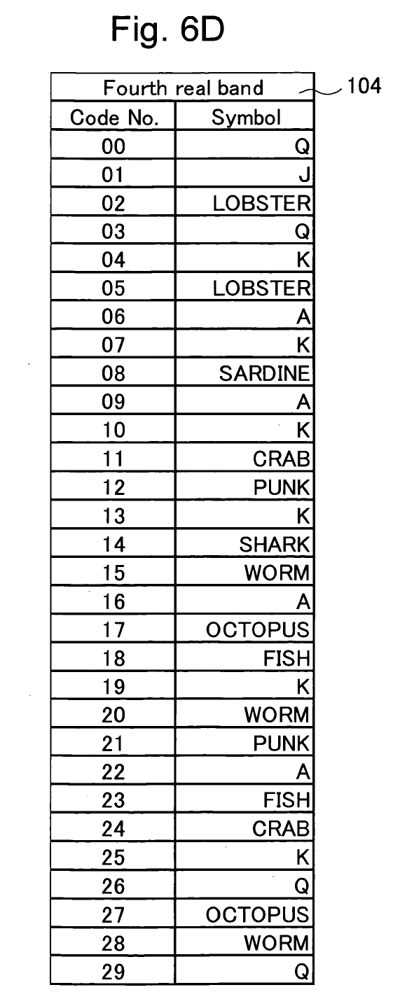

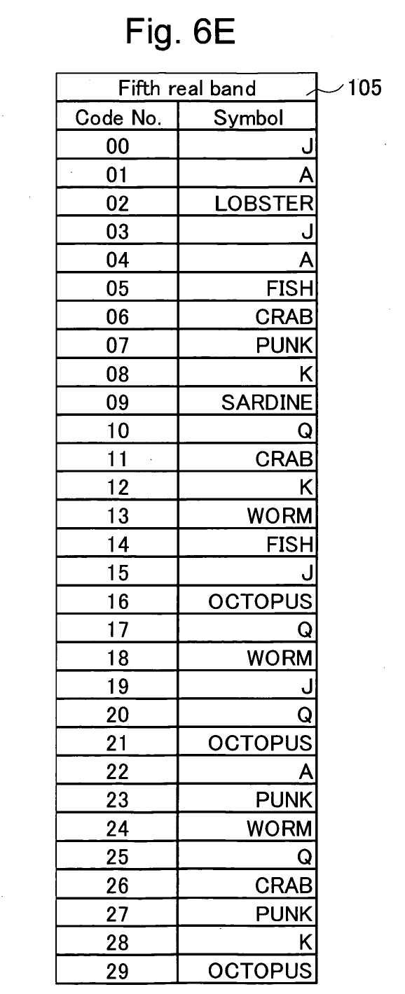

Next, symbol examples will be described with reference to FIG. 6. The symbol examples are displayed on the lower liquid crystal display 4 during a normal game and are varied while being scrolled in the variable display windows 21 to 25. In FIG. 6, the column of symbols indicated on a first reel band 101 is a column of symbols to be varied in the variable display window 21. The column of symbols indicated on a second reel band 102 is a column of symbols to be varied in the variable display window 22. The column of symbols indicated on a third reel band 103 is a column of symbols to be varied in the variable display window 23. The column of symbols indicated on a fourth reel band 104 is a column of symbols to be varied in the variable display window 24. The column of symbols indicated on a fifth reel band 105 is a column of symbols to be varied in the variable display window 25.

Here, the columns of symbols indicated on the reel bands 101 to 105 have symbol arrangements, which are different from each other. Each of the columns of symbols has a combination of twelve symbols of “LOBSTER”, “SHARK”, “FISH”, “PUNK”, “OCTOPUS”, “CRAB”, “WORM”, “A”, “K”, “Q”, “J” and “SARDINE”.

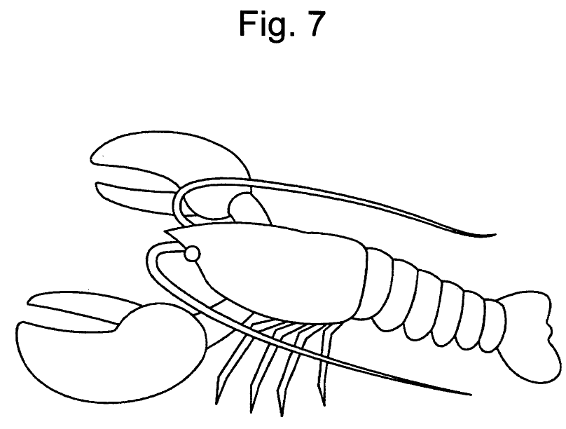

“LOBSTER” refers to a lobster symbol as shown in FIG. 7. “SHARK”, “FISH”, “PUNK”, “OCTOPUS”, “CRAB”, “WORM” and “SARDINE” refer to shark, fish, punk, octopus, crab, worm and sardine symbols, not shown, respectively. “A”, “K”, “Q” and “J” refer to alphabetical symbols.

“SARDINE” also functions as a scatter symbol for shifting to a bonus game as described later. When three or more “SARDINE” symbols are stopped in the variable display windows 21 to 25 in total, the shift to the bonus game is allowed independently of activated pay lines.

Three symbols are stopped in each of the variable display windows 21 to 25 as described above after the columns of symbols indicated on the reel bands 101 to 105 are scrolled in the variable display windows 21 to 25.

Winning combinations are predefined based on multiple kinds of combination of the symbols, and a payout in accordance with a winning combination is added to a credit value when a combination of symbols corresponding to the winning combination is stopped on an activated pay line, the description of which will be omitted herein because it is similar to that of a conventional slot machine.

Next, a configuration of a control system of the slot machine 1 will be described with reference to FIG. 4. FIG. 4 is a block diagram schematically showing the control system of the slot machine 1.

In FIG. 4, the control system of the slot machine 1 basically includes the CPU 50 as a core, and a ROM 51 and a RAM 52 are connected to the CPU 50. The ROM 51 includes a main processing program, normal game processing program, bonus game processing program, lottery table for drawing a stopped symbol in a normal game, lottery table for drawing a stopped symbol in a bonus game, and other programs required for controlling the slot machine 1 and data table, which will be described later. The RAM 52 is a memory for temporarily storing data computed in the CPU 50.

A clock pulse generator circuit 53 for generating a reference clock pulse and a frequency divider 54 and a random number generator 55 for generating a random number and a random number sampling circuit 56 are connected to the CPU 50. A sampled random number is used for a lottery for a winning combination through the random number sampling circuit 56. COLLECT switch 45 associated with COLLECT button 31, GAME-RULES switch 46 associated with GAME RULES button 32, 1-BET switch 57 associated with BET 1 PER LINE button 33, 2-BET switch 58 associated with BET 2 PER LINE button 34, 3-BET switch 59 associated with BET 3 PER LINE button 35, 5-BET switch 60 associated with BET 5 PER LINE button 36, 8-BET switch 61 associated with BET 8 PER LINE button 37, WIN-START switch 47 associated with WIN START FEATURE button 38, 1-LINE switch 62 associated with RED PLAY 1 LINE button 39, 2-LINES switch 63 associated with PLAY 2 LINES button 40, 5-LINES switch 64 associated with PLAY 5 LINES button 41, 20-LINES switch 65 associated with PLAY 20 LINES button 42, 25-LINES switch 66 associated with BLACK PLAY 25 LINES button 43 and GAMBLE-RESERVE switch 48 associated with GAMBLE RESERVE button 44 are further connected to the CPU 50. The CPU 50 controls to perform an operation corresponding to each of the buttons based on a switch signal output from the switch based on the pressed corresponding button.

A coin sensor 49 placed in the coin insertion slot 9 and a bill sensor 67 placed in the paper money insertion slot 10 are connected to the CPU 50. The coin sensor 49 detects a coin inserted from the coin insertion slot 9, and the CPU 50 computes the number of inserted coins based on a coin detection signal output from the coin sensor 49. The bill sensor 67 detects the kind and amount of paper money inserted from the paper money insertion slot 10. The CPU 50 computes the credit value equivalent to the amount of paper money based on a bill detection signal output from the bill sensor 67.

A hopper 71 is connected to the CPU 50 through a hopper driver circuit 70. When a drive signal is output from the CPU 50 to the hopper driver circuit 70, the hopper 71 pays out a predetermined number of coins from the coin payout opening 15.

A coin detecting unit 73 is further connected to the CPU 50 through a payout completion signal circuit 72. The coin detecting unit 73 is placed inside of the coin payout opening 15. When the coin detecting unit 73 detects that a predetermined number of coins are paid out from the coin payout opening 15, a coin payout detection signal is output from the coin detecting unit 73 to the payout completion signal circuit 72. Based on the coin payout detection signal, the payout completion signal circuit 72 outputs a payout completion signal to the CPU 50. The upper liquid crystal display 3 and lower liquid crystal display 4 are further connected to the CPU 50 through a liquid crystal driver circuit 74, and the upper liquid crystal display 3 and lower liquid crystal display 4 are controlled by the CPU 50.

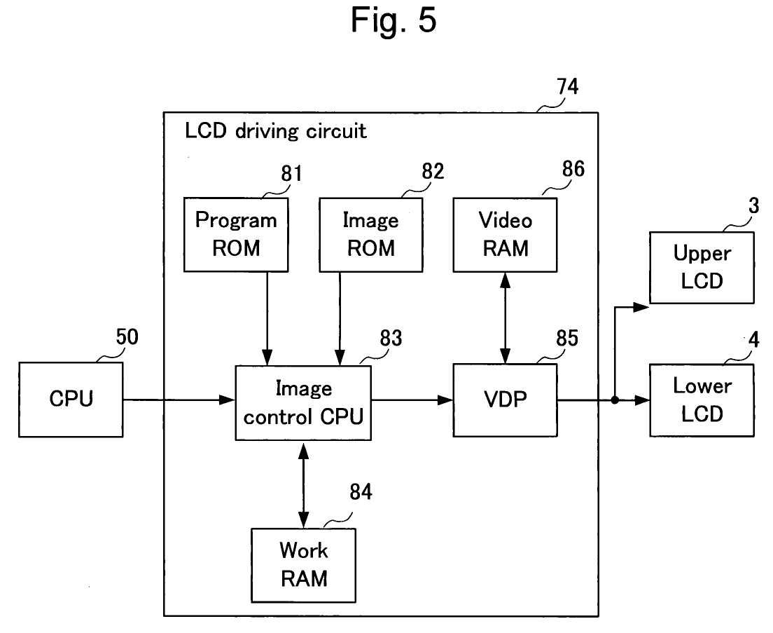

As shown in FIG. 5, the liquid crystal driver circuit 74 includes a program ROM 81, an image ROM 82, an image control CPU 83, a work RAM 84, a video display processor (VDP) 85 and a video RAM 86. The program ROM 81 stores an image control program and select table relating to the displays on the upper liquid crystal display 3 and lower liquid crystal display 4. The image ROM 82 stores dot data for forming an image such as the columns of symbols indicated on the reel bands 101 to 105 in FIG. 6 displayed on the lower liquid crystal display 4 (or in the variable display windows 21 to 25). The image control CPU 83 determines an image to be displayed on the upper liquid crystal display 3 or lower liquid crystal display 4 from dot data prestored in the image ROM 82 based on a parameter defined by the CPU 50 and in accordance with an image control program prestored in the program ROM 81. The work RAM 84 functions as a temporary storage device for executing the image control program by the image control CPU 83. The VDP 85 forms an image in accordance with the contents to display, which is determined by the image control CPU 83, and outputs the result to the upper liquid crystal display 3 or lower liquid crystal display 4. Thus, the columns of symbols indicated on the reel bands 101 to 105 may be scrolled on the lower liquid crystal display 4 (or in the variable display windows 21 to 25), for example. The video RAM 86 functions as a temporary storage device to be used for forming an image by the VDP 85.

LEDs 78 are further connected to the CPU 50 through an LED driver circuit 77. Many LEDs 78 are placed on the front face of the slot machine 1, and the lighting of the LED 78 is controlled by the LED driver circuit 77 based on a drive signal from the CPU 50 for implementing various effects. A sound output circuit 79 and a speaker 80 are further connected to the CPU 50. The speaker 80 produces various sound effects for implementing various effects based on output signals from the sound output circuit 79.

The touch panel 121 is further connected to the CPU 50 through a touch panel driver circuit 122. The touch panel 121 is provided on the screen of the lower liquid crystal display 4. When one of the variable display windows 21 to 25 is touched, the touch panel 121 can not only recognize the touched one of the variable display windows 21 to 25 through the touch panel driver circuit 122 but also identifies the touched one of the first stop areas 211, 221, 231, 241 and 251 for display, the second stop areas 212, 222, 232, 242 and 252 for display and the third stop areas 213, 223, 233, 243 and 253 for display.

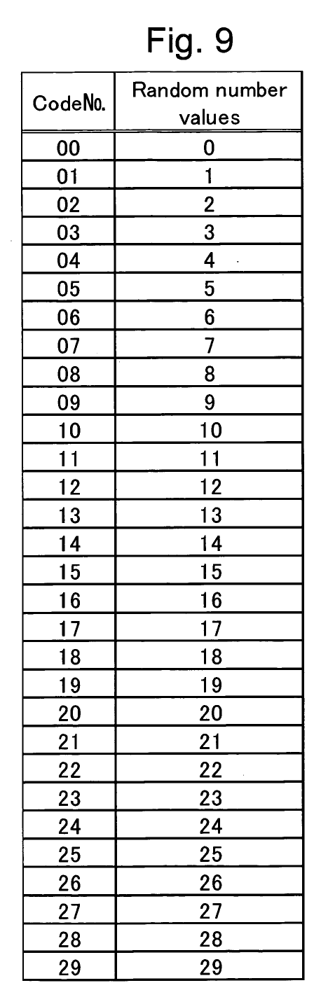

The lottery table used for determining symbols stopped on the activated pay line L1 in FIG. 11 in order to implement a normal game by using the five variable display windows 21 to 25 in the slot machine 1 will be described with reference to FIG. 9. FIG. 9 is an explanatory diagram showing the lottery table for symbols in order to implement a normal game by using the five variable display windows.

Symbols to be stopped on the activated pay line L1 shown in FIG. 11 are determined for each of the variable display windows 21 to 25. In order to do so, code numbers of “00” to “29” are sequentially assigned to the columns of symbols scrolled in the variable display windows 21 to 25 and indicated on the reel bands 101 to 105 in FIG. 6 while the lottery table as shown in FIG. 9 is provided. Then, five random number values corresponding to the variable display windows 21 to 25, respectively, are sampled through the random number sampling circuit 56.

For the column of the symbols scrolled in the variable display window 21 and indicated on the first reel band 101 in FIG. 6, when the random number value sampled through the random number sampling circuit 56 is “0”, the “J” symbol (alphabet) assigned to Code Number “00” is stopped to appear on the activated pay line L1 shown in FIG. 11. When the random number value is “1”, the “Q” symbol (alphabet) assigned to Code Number “01” is stopped to appear on the activated pay line L1 shown in FIG. 11. When the random number value is “2”, the “LOBSTER” symbol (see the lobster in FIG. 7) assigned to Code Number “02” is stopped to appear on the activated pay line L1 shown in FIG. 11. When the random number value is “3”, the “J” symbol (alphabet) assigned to Code Number “03” is stopped to appear on the activated pay line L1 shown in FIG. 11. When the random number value is “4”, the “Q” symbol (alphabet) assigned to Code Number “04” is stopped to appear on the activated pay line L1 shown in FIG. 11. When the random number value is “5”, the “CRAB” symbol (crab) assigned to Code Number “05” is stopped to appear on the activated pay line L1 shown in FIG. 11. When the random number value is “6”, the “A” symbol (alphabet) assigned to Code Number “06” is stopped to appear on the activated pay line L1 shown in FIG. 11. When the random number value is “7”, the “WORM” symbol (worm) assigned to Code Number “07” is stopped to appear on the activated pay line L1 shown in FIG. 11. When the random number value is “8”, the “K” symbol (alphabet) assigned to Code Number “08” is stopped to appear on the activated pay line L1 shown in FIG. 11. When the random number value is “9”, the “FISH” symbol (fish) assigned to Code Number “09” is stopped to appear on the activated pay line L1 shown in FIG. 11. When the random number value is “10”, the “PUNK” symbol (punk) assigned to Code Number “10” is stopped to appear on the activated pay line L1 shown in FIG. 11.

When the random number value is “11”, the “Q” symbol (alphabet) assigned to Code Number “11” is stopped to appear on the activated pay line L1 shown in FIG. 11. When the random number value is “12”, the “SHARK” symbol (shark) assigned to Code Number “12” is stopped to appear on the activated pay line L1 shown in FIG. 11. When the random number value is “13”, the “CRAB” symbol (crab) assigned to Code Number “13” is stopped to appear on the activated pay line L1 shown in FIG. 11. When the random number value is “14”, the “K” symbol (alphabet) assigned to Code Number “14” is stopped to appear on the activated pay line L1 shown in FIG. 11. When the random number value is “15”, the “A” symbol (alphabet) assigned to Code Number“15” is stopped on the activated pay line L1 shown in FIG. 11. When the random number value is “16”, the “OCTOPUS” symbol (octopus) assigned to Code Number “16” is stopped to appear on the activated pay line L1 shown in FIG. 11. When the random number value is “17”, the “J” symbol (alphabet) assigned to Code Number “17” is stopped to appear on the activated pay line L1 shown in FIG. 11. When the random number value is “18”, the “Q” symbol (alphabet) assigned to Code Number “18” is stopped to appear on the activated pay line L1 shown in FIG. 11. When the random number value is “19”, the “FISH” symbol (fish) assigned to Code Number “19” is stopped to appear on the activated pay line L1 shown in FIG. 11.

When the random number value is “20”, the “K” symbol (alphabet) assigned to Code Number “20” is stopped to appear on the activated pay line L1 shown in FIG. 11. When the random number value is “21”, the “J” symbol (alphabet) assigned to Code Number “21” is stopped to appear on the activated pay line L1 shown in FIG. 11. When the random number value is “22”, the “SARDINE” symbol (sardine) assigned to Code Number “22” is stopped to appear on the activated pay line L1 shown in FIG. 11. When the random number value is “23”, the “CRAB” symbol (crab) assigned to Code Number “23” is stopped to appear on the activated pay line L1 shown in FIG. 11. When the random number value is “24”, the “J” symbol (alphabet) assigned to Code Number “24” is stopped to appear on the activated pay line L1 shown in FIG. 11. When the random number value is “25”, the “WORM” symbol (worm) assigned to Code Number “25” is stopped to appear on the activated pay line L1 shown in FIG. 11. When the random number value is “26”, the “Q” symbol (alphabet) assigned to Code Number “26” is stopped to appear on the activated pay line L1 shown in FIG. 11. When the random number value is “27”, the “CRAB” symbol (crab) assigned to Code Number “27” is stopped to appear on the activated pay line L1 shown in FIG. 11. When the random number value is “28”, the “A” symbol (alphabet) assigned to Code Number “28” is stopped to appear on the activated pay line L1 shown in FIG. 11. When the random number value is “29”, the “FISH” symbol (fish) assigned to Code Number “29” is stopped to appear on the activated pay line L1 shown in FIG. 11.

Notably, the same control is performed on the column of symbols scrolled in the variable display window 22 and indicated on the second reel band 102 in FIG. 6, the column of symbols scrolled in the variable display window 23 and indicated on the third reel band 103 in FIG. 6, the column of symbols scrolled in the variable display window 24 and indicated on the fourth reel band 104 in FIG. 6 and the column of symbols scrolled in the variable display window 25 and indicated on the fifth reel band 105 in FIG. 6.

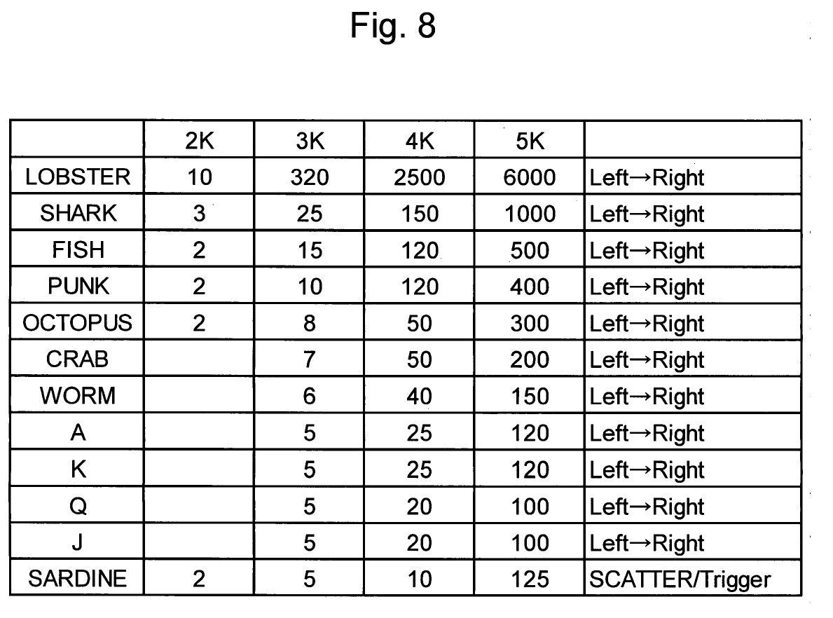

Next, winning combinations and payouts thereof to be implemented when a normal game is performed by using the five variable display windows 21 to 25 in the slot machine 1 will be described with reference to FIG. 8. FIG. 8 is an explanatory diagram showing winning combinations and payouts thereof to be implemented when a normal game is performed by using the five variable display windows and shows payouts for a BET value of “1”. Therefore, when the BET value is “1”, the value of the payout shown in FIG. 8 is added to a credit value while, when the BET value is “2” or a larger number, the value of the payout obtained by multiplying a corresponding value shown in FIG. 8 by the BET value is added to the credit value.

More specifically describing winning combinations and payouts thereof to be implemented when a normal game is performed, consecutively showing the “LOBSTER” symbol (the lobster in FIG. 7) on an activated pay line in the variable display windows 21 and 22 (in the case of “2K” indicating that the symbol appears twice consecutively from the left end) as shown in FIG. 8 results in a payout of “10”. Consecutively showing the “LOBSTER” symbol on an activated pay line in the variable display windows 21 to 23 (in the case of “3K” indicating that the symbol appears three times consecutively from the left end) results in a payout of “320”. Consecutively showing the “LOBSTER” symbol on an activated pay line in the variable display windows 21 to 24 (in the case of “4K” indicating that the symbol appears four times consecutively from the left end) results in a payout of “2500”. Consecutively showing the “LOBSTER” symbol on an activated pay line in the variable display windows 21 to 25 (in the case of “5K” indicating that the symbol appears fifth times consecutively from the left end) results in a payout of “6000”.

Consecutively showing the “SHARK” symbol (shark) on an activated pay line in the variable display windows 21 and 22 (in the case of “2K” indicating that the symbol appears twice consecutively from the left end) results in a payout of “3”. Consecutively showing the “SHARK” symbol on an activated pay line in the variable display windows 21 to 23 (in the case of “3K” indicating that the symbol appears three times consecutively from the left end) results in a payout of “25”. Consecutively showing the “SHARK” symbol on an activated pay line in the variable display windows 21 to 24 (in the case of “4K” indicating that the symbol appears four times consecutively from the left end) results in a payout of “150”. Consecutively showing the “SHARK” symbol on an activated pay line in the variable display windows 21 to 25 (in the case of “5K” indicating that the symbol appears fifth times consecutively from the left end) results in a payout of “1000”.

Consecutively showing the “FISH” symbol (fish) on an activated pay line in the variable display windows 21 and 22 (in the case of “2K” indicating that the symbol appears twice consecutively from the left end) results in a payout of “2”. Consecutively showing the “FISH” symbol on an activated pay line in the variable display windows 21 to 23 (in the case of “3K” indicating that the symbol appears three times consecutively from the left end) results in a payout of “15”. Consecutively showing the “FISH” symbol on an activated pay line in the variable display windows 21 to 24 (in the case of “4K” indicating that the symbol appears four times consecutively from the left end) results in a payout of “120”. Consecutively showing the “FISH” symbol on an activated pay line in the variable display windows 21 to 25 (in the case of “5K” indicating that the symbol appears fifth times consecutively from the left end) results in a payout of “500”.

Consecutively showing the “PUNK” symbol (punk) on an activated pay line in the variable display windows 21 and 22 (in the case of “2K” indicating that the symbol appears twice consecutively from the left end) results in a payout of “2”. Consecutively showing the “PUNK” symbol on an activated pay line in the variable display windows 21 to 23 (in the case of “3K” indicating that the symbol appears three times consecutively from the left end) results in a payout of “10”. Consecutively showing the “PUNK” symbol on an activated pay line in the variable display windows 21 to 24 (in the case of “4K” indicating that the symbol appears four times consecutively from the left end) results in a payout of “120”. Consecutively showing the “PUNK” symbol on an activated pay line in the variable display windows 21 to 25 (in the case of “5K” indicating that the symbol appears fifth times consecutively from the left end) results in a payout of “400”.

Consecutively showing the “OCTOPUS” symbol (octopus) on an activated pay line in the variable display windows 21 and 22 (in the case of “2K” indicating that the symbol appears twice consecutively from the left end) results in a payout of “2”. Consecutively showing the “OCTOPUS” symbol on an activated pay line in the variable display windows 21 to 23 (in the case of “3K” indicating that the symbol appears three times consecutively from the left end) results in a payout of “8”. Consecutively showing the “OCTOPUS” symbol on an activated pay line in the variable display windows 21 to 24 (in the case of “4K” indicating that the symbol appears four times consecutively from the left end) results in a payout of “50”. Consecutively showing the “OCTOPUS” symbol on an activated pay line in the variable display windows 21 to 25 (in the case of “5K” indicating that the symbol appears fifth times consecutively from the left end) results in a payout of “300”.

Consecutively showing the “CRAB” symbol (crab) on an activated pay line in the variable display windows 21 to 23 (in the case of “3K” indicating that the symbol appears three times consecutively from the left end) results in a payout of “7”. Consecutively showing the “CRAB” symbol on an activated pay line in the variable display windows 21 to 24 (in the case of “4K” indicating that the symbol appears four times consecutively from the left end) results in a payout of “50”. Consecutively showing the “CRAB” symbol on an activated pay line in the variable display windows 21 to 25 (in the case of “5K” indicating that the symbol appears fifth times consecutively from the left end) results in a payout of “200”.

Consecutively showing the “WORM” symbol (worm) on an activated pay line in the variable display windows 21 to 23 (in the case of “3K” indicating that the symbol appears three times consecutively from the left end) results in a payout of “6”. Consecutively showing the “WORM” symbol on an activated pay line in the variable display windows 21 to 24 (in the case of “4K” indicating that the symbol appears four times consecutively from the left end) results in a payout of “40”. Consecutively showing the “WORM” symbol on an activated pay line in the variable display windows 21 to 25 (in the case of “5K” indicating that the symbol appears fifth times consecutively from the left end) results in a payout of “150”.

Consecutively showing the “A” symbol (alphabet) on an activated pay line in the variable display windows 21 to 23 (in the case of “3K” indicating that the symbol appears three times consecutively from the left end) results in a payout of “5”. Consecutively showing the “A” symbol on an activated pay line in the variable display windows 21 to 24 (in the case of “4K” indicating that the symbol appears four times consecutively from the left end) results in a payout of “25”. Consecutively showing the “A” symbol on an activated pay line in the variable display windows 21 to 25 (in the case of “5K” indicating that the symbol appears fifth times consecutively from the left end) results in a payout of “120”.

Consecutively showing the “K” symbol (alphabet) on an activated pay line in the variable display windows 21 to 23 (in the case of “3K” indicating that the symbol appears three times consecutively from the left end) results in a payout of “5”. Consecutively showing the “K” symbol on an activated pay line in the variable display windows 21 to 24 (in the case of “4K” indicating that the symbol appears four times consecutively from the left end) results in a payout of “25”. Consecutively showing the “K” symbol on an activated pay line in the variable display windows 21 to 25 (in the case of “5K” indicating that the symbol appears five times consecutively from the left end) results in a payout of “120”.

Consecutively showing the “Q” symbol (alphabet) on an activated pay line in the variable display windows 21 to 23 (in the case of “3K” indicating that the symbol appears three times consecutively from the left end) results in a payout of “5”. Consecutively showing the “Q” symbol on an activated pay line in the variable display windows 21 to 24 (in the case of “4K” indicating that the symbol appears four times consecutively from the left end) results in a payout of “20”. Consecutively showing the “Q” symbol on an activated pay line in the variable display windows 21 to 25 (in the case of “5K” indicating that the symbol appears five times consecutively from the left end) results in a payout of “100”.

Consecutively showing the “J” symbol (alphabet) on an activated pay line in the variable display windows 21 to 23 (in the case of “3K” indicating that the symbol appears three times consecutively from the left end) results in a payout of “5”. Consecutively showing the “J” symbol on an activated pay line in the variable display windows 21 to 24 (in the case of “4K” indicating that the symbol appears four times consecutively from the left end) results in a payout of “20”. Consecutively showing the “J” symbol on an activated pay line in the variable display windows 21 to 25 (in the case of “5K” indicating that the symbol appears five times consecutively from the left end) results in a payout of “100”.

When the above-mentioned symbols for payouts appear on multiple activated pay lines, the total value of all of the payouts is added to the credit value.

On the other hand, the payout of the “SARDINE” symbol is irrelevant to the activated pay lines, and when two “SARDINE” symbols (stopped to appear) appear on the variable display windows 21 to 25 to make “2K”, a payout of “2” is paid. When three “SARDINE” symbols (stopped to appear) appear on the variable display windows 21 to 25 to make “3K”, a payout of “5” is paid. When four “SARDINE” symbols (stopped to appear) appear on the variable display windows 21 to 25 to make “4K”, a payout of “10” is paid. When five “SARDINE” symbols (stopped to appear) appear on the variable display windows 21 to 25 to make “5K”, a payout of “125” is paid.

Notably, only for the payout by the “SARDINE” symbol, the payout resulting from multiplying the corresponding value shown in FIG. 8 by a total BET value (that is, the product of BET value and number of activated pay lines) is added to the credit value. When there is a payout other than “SARDINE” symbol, the payout is also added to the credit value.

When three or more “SARDINE” symbols (stopped to appear) in total appear on the variable display windows 21 to 25 independently of the activated pay lines, the payout is made and shifting to a bonus game can be made.

The term, “bonus game” refers to a game to be performed after a normal game is performed, and the bonus game may generally be more advantageous to the player. Here, in the bonus game, for example, 15 to 25 games are automatically implemented without betting any credit in accordance with a lottery result during shifting to the bonus game.

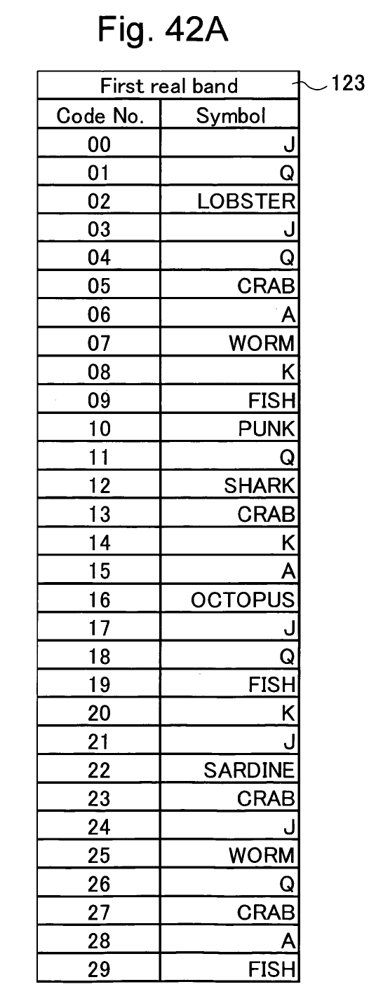

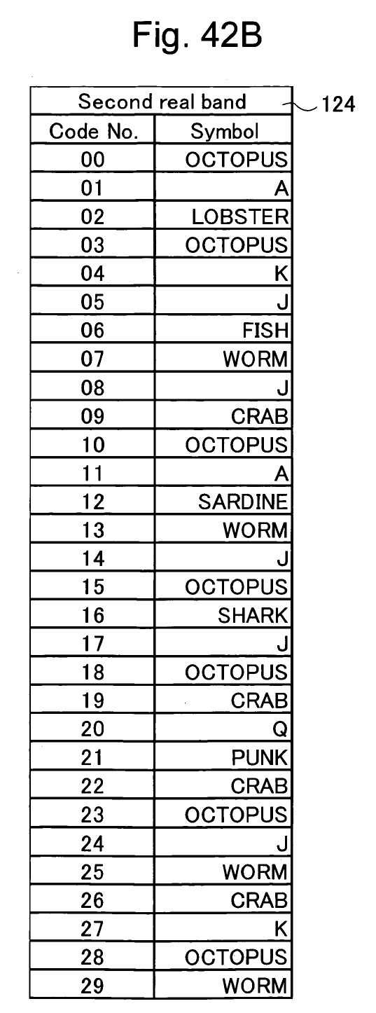

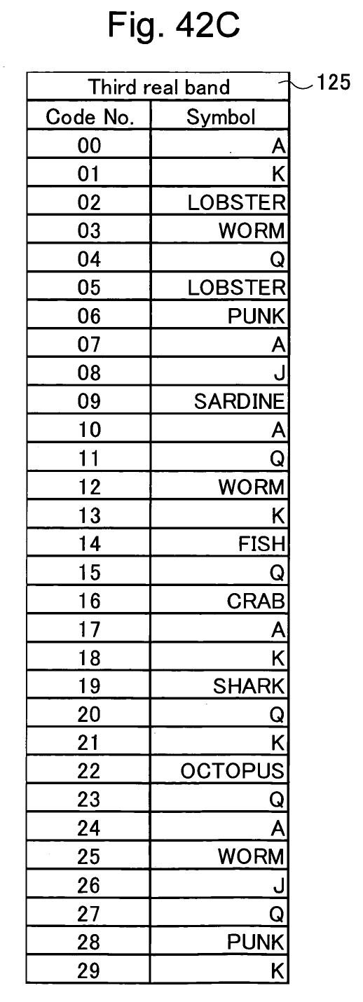

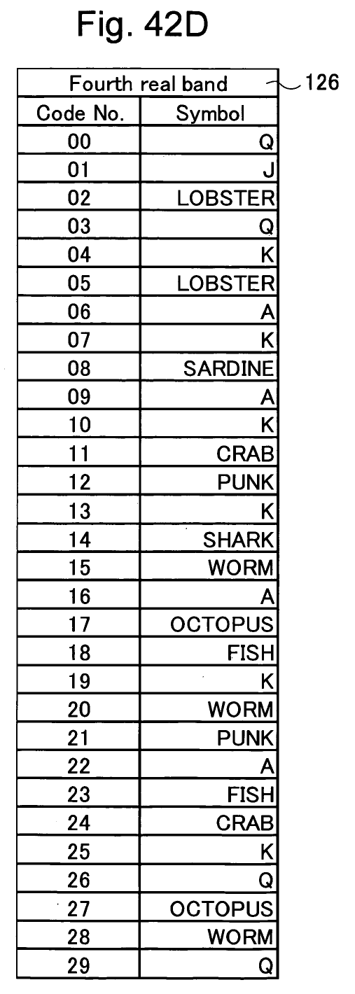

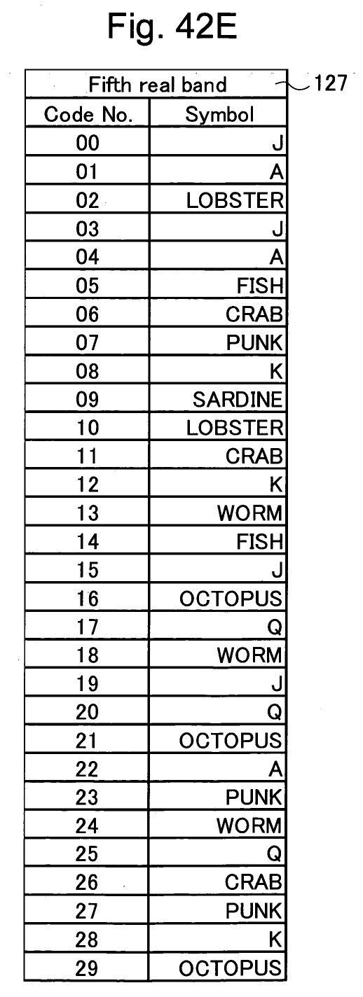

It should be noted that, in the slot machine 1 of this embodiment, the column of symbols being scrolled and varied in the variable display window 21 of the lower liquid crystal display 4 in the bonus game is a column of symbols indicated on the first reel band 123 as shown in FIG. 42. The column of symbols being scrolled and varied in the variable display window 22 of the lower liquid crystal display 4 is a column of symbols indicated on the second reel band 124 as shown in FIG. 42. The column of symbols being scrolled and varied in the variable display window 23 of the lower liquid crystal display 4 is a column of symbols indicated on the third reel band 125 as shown in FIG. 42. The column of symbols being scrolled and varied in the variable display window 24 of the lower liquid crystal display 4 is a column of symbols indicated on the fourth reel band 126 as shown in FIG. 42. The column of symbols being scrolled and varied in the variable display window 25 of the lower liquid crystal display 4 is a column of symbols indicated on the fifth reel band 127 as shown in FIG. 42.

The columns of symbols indicated on the reel bands 123 to 126 as shown in FIG. 42 are identical to the columns of symbols indicated on the reel bands 101 to 104 in FIG. 6, which are used in a normal game. On the other hand, the column of symbols indicated on the reel band 127 as shown in FIG. 42 is identical to the column of symbols indicated on the reel band 105 in FIG. 6, which is used in a normal game, except for the “LOBSTER” symbol (see the lobster in FIG. 7) assigned to the code number, “10”.

The BET value and number of activated pay lines in the bonus game are those upon shift to the bonus game. Although the winning combinations and payouts thereof in the bonus game are identical to those of the normal game, the “SHARK” symbol is handled as the “LOBSTER” symbol (see the lobster in FIG. 7) and, the bonus game can be shifted to again when three “SARDINE” symbols appear (stopped to appear). Therefore, the player can often get much more credits.

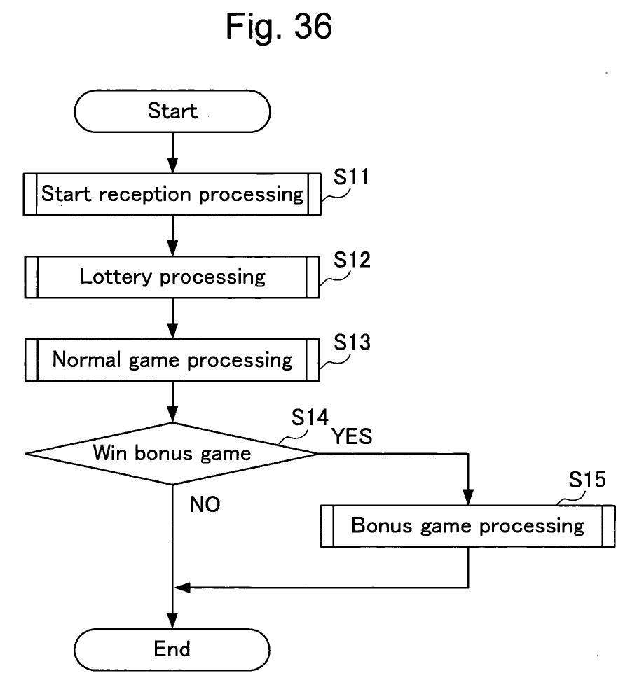

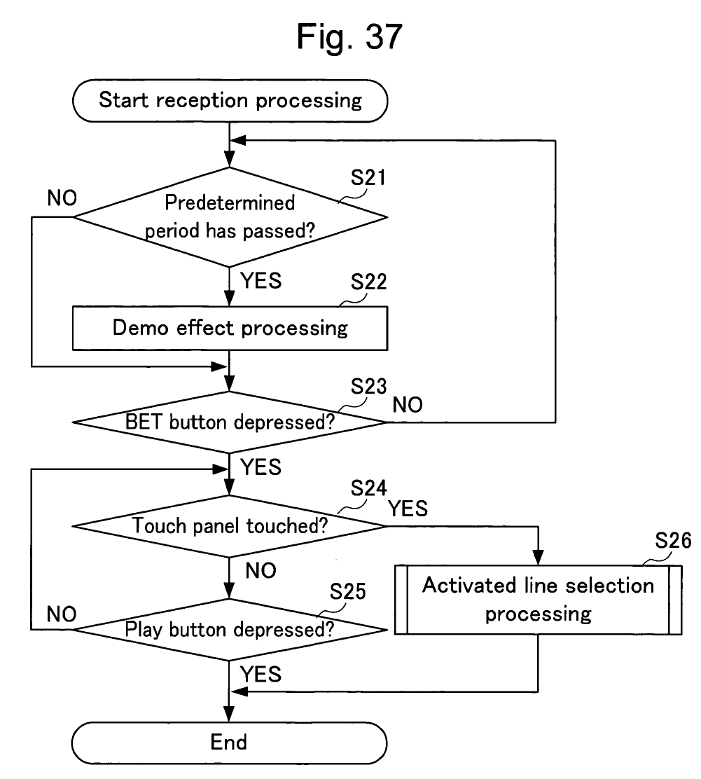

Next, a main processing program to be executed in the slot machine 1 will be described with reference to FIG. 36. FIG. 36 is a flowchart of the main processing program. In FIG. 36, start reception processing, which will be described later, in FIG. 37 is performed in step 11 (“S11” for short) first. The processing is processing for receiving a switch signal output from the 1-BET switch 57, 2-BET switch 58, 3-BET switch 59, 5-BET switch 60, 8-BET switch 61, 1-LINE switch 62, 2-LINES switch 63, 5-LINES switch 64, 20-LINES switch 65 or 25-LINES switch 66 based on manipulations on the BET 1 PER LINE button 33, BET 2 PER LINE button 34, BET 3 PER LINE button 35, BET 5 PER LINE button 36, BET 8 PER LINE button 37, RED PLAY 1 LINE button 39, PLAY 2 LINES button 40, PLAY 5 LINES button 41, PLAY 20 LINES button 42 or BLACK PLAY 25 LINES button 43. Upon receipt of the switch signal output from one of these switches, a game is started.

The processing is also reception processing for receiving a control signal output from the touch panel driver circuit 122 based on the contact to the touch panel 121.

In S12, lottery processing in FIG. 16, which will be described later, is performed based on a switch signal output from the 1-LINE switch 62, 2-LINES switch 63, 5-LINES switch 64, 20-LINES switch 65 or 25-LINES switch 66.

Here, if a bonus game is won, the number of repetition of the bonus game is determined, and one value for repetition of games among numbers from 10 to 25 is selected by a lottery.

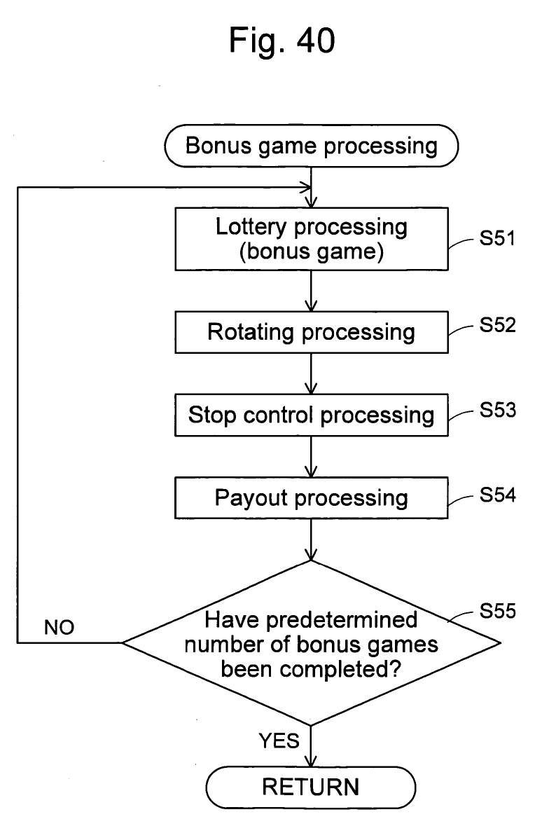

In next S13, normal game processing in FIG. 17, which will be described later, is performed. Then, the processing moves to S14 where whether a bonus game has been won or not is determined. More specifically, in the lottery processing in S12, if three or more “SARDINE” symbols (sardine) in total appear (stopped to appear) on the variable display windows 21 to 25 independently of activated pay lines, a bonus game is won (YES in S14). Therefore, the processing moves to S15 where bonus game processing in FIG. 40, which will be described later, is performed. Then, the main processing program ends. On the other hand, if three or more “SARDINE” symbols in total do not appear (stopped to appear) on the variable display windows 21 to 25 independently of activated pay lines in the lottery processing in S12, no bonus game is won (NO in S14). Therefore, the main processing program ends.

Next, the start reception processing program to be executed in the slot machine 1 will be described with reference to FIG. 37. FIG. 37 is a flowchart of the start reception processing program. In order to perform the start reception processing in S11 of the main processing program in FIG. 36, the processing moves to S21 in FIG. 37 first where whether a predetermined period of time (such as 15 seconds) has passed or not is determined. If it is determined that the predetermined period of time has not passed (NO in S21) here, the processing moves to S23 without performing anything. If it is determined that the predetermined period of time has passed (YES in S21), a demo-effect is implemented on the upper liquid crystal display 3 and/or lower liquid crystal display 4 in S22, which is followed by the S23. In S23, whether any manipulation is performed on the BET 1 PER LINE button 33, BET 2 PER LINE button 34, BET 3 PER LINE button 35, BET 5 PER LINE button 36 or BET 8 PER LINE button 37 or not is determined. If it is determined that no manipulation is performed on the BET 1 PER LINE button 33 or others (NO in S23) here, the processing returns to S21 and repeats the above-described processing. On the other hand, if it is determined that the BET 1 PER LINE button 33 or others is manipulated (YES in S23), the processing moves to S23 even in the middle of the demo-effect.

The determination processing in S23 may be based on not only the manipulation signal but also other input signals.

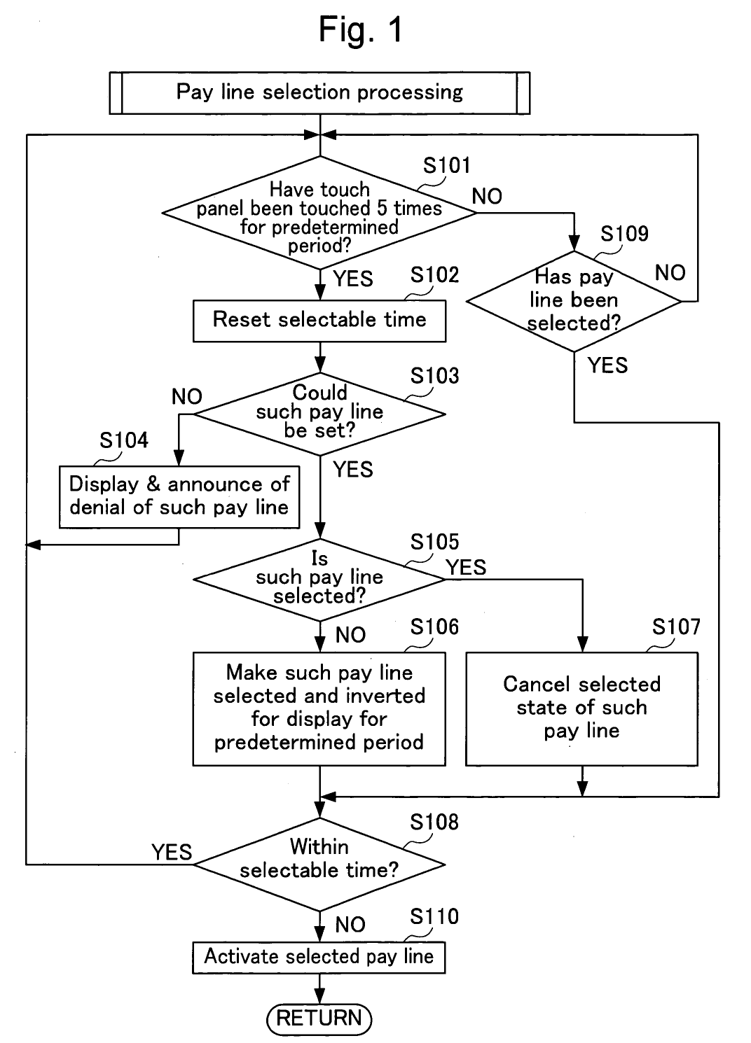

In S23, it is determined whether any one of the first stop areas 211, 221, 231, 241 and 251 for display, the second stop areas 212, 222, 232, 242 and 252 for display and the third stop areas 213, 223, 233, 243 and 253 for display is touched through the touch panel 121 or not. If it is determined that one of the first stop areas 211, 221, 231, 241 and 251 for display is touched through the touch panel 121 (YES in S24), the processing moves to S26 where activated line selection processing in FIG. 1, which will be described later, is performed. Then, the processing returns to the main processing program in FIG. 36 and moves to the lottery processing in S12. On the other hand, if it is determined that none of the first stop areas 211, 221, 231, 241 and 251 for display are touched through the touch panel 121 (NO in S24), the processing moves to S25.

In S25, whether any manipulation has been performed on the RED PLAY 1 LINE button 39, PLAY 2 LINES button 40, PLAY 5 LINES button 41, PLAY 20 LINES button 42 or BLACK PLAY 25 LINES button 43 or not is determined. If it is determined that no manipulation has been performed on the RED PLAY 1 LINE button 39, PLAY 2 LINES button 40, PLAY 5 LINES button 41, PLAY 20 LINES button 42, or BLACK PLAY 25 LINES button 43 (NO in S25) here, the processing returns to S24 where the above-described processing is repeated. On the other hand, if it is determined that the RED PLAY 1 LINE button 39, PLAY 2 LINES button 40, PLAY 5 LINES button 41, PLAY 20 LINES button 42, or BLACK PLAY 25 LINES button 43 has been operated (YES in S25), the processing returns to the main processing program in FIG. 36 even in the middle of the demo effect above and moves to the lottery processing in S12.

Now, an activated line selection processing program to be executed in S26 will be described with reference to FIG. 1. FIG. 1 is a flowchart of the activated line selection processing program. That is, in the beginning of the activated line selection processing in S26 in FIG. 37, whether any one of the first stop areas 211, 221, 231, 241 and 251 for display, the second stop areas 212, 222, 232, 242 and 252 for display and the third stop areas 213, 223, 233, 243 and 253 for display is touched for five times through the touch panel 121 or not is determined in S101 as shown in FIG. 1. If it is determined that one of the first stop areas 211, 221, 231, 241 and 251 for display is touched for five times through the touch panel 121 (YES in S101) here, the processing moves to S102 where the selectable time to be counted by using the clock pulse generator circuit 53, for example, is reset, and the measurement is started.

Then, in S103, whether the pay line spanning the five stop areas for display touched through the touch panel 121 can be set as pay line or not is determined among the first stop areas 211, 221, 231, 241 and 251 for display, second stop areas 212, 222, 232, 242 and 252 for display and third stop areas 213, 223, 233, 243 and 253 for display. The determination may be based on the current video slot regulation that the pay line does not span two or more stop areas for display in the variable display windows 21 to 25. However, the present invention is not limited thereto if the compliance with the current video slot regulation is not required. If it is determined that the pay line cannot be set here (NO in S103), the processing moves to S104 where the fact that the pay line cannot be set is displayed on the upper liquid crystal display 3 and is output from the speaker 80. Then, the processing returns to S101, and the above-described processing is repeated. On the other hand, if it is determined that the pay lines can be set (YES in S103), the processing moves to S105.

Then, in S105, whether the pay line is selected or not is determined. If it is determined that the pay line is not selected here (NO in S105), the processing moves to S106 where the pay line is selected and a stop area for display spanned by the pay line is inverted within a predetermined period of time among the first stop areas 211, 221, 231, 241 and 251 for display, second stop areas 212,222, 232, 242 and 252 for display and third stop areas 213, 223, 233, 243 and 253 for display. Then, the processing moves to S108.

On the other hand, if it is determined that the pay line is selected (YES in S105), the processing moves to S107 where the selected state of the pay line is cancelled. Then, the processing moves to S108.

Then, in S108, whether it is within the selectable time or not is determined. If it is determined that it is within the selectable time (YES in S108) here, the processing returns to S101, and the above-described processing is repeated. On the other hand, if it is determined that it is not within the selectable time (NO in S108), the processing moves to S110 where all of the selected pay lines are made activated. Then, the processing returns to the start reception processing in FIG. 37 and further returns to the main processing program in FIG. 36 and moves to the lottery processing in S12.

Notably, if it is determined in S101 that one of he first stop area 211, 221, 231, 241 and 251 for display is not touched five times through the touch panel 121 (NO in S101), the processing moves to S109 where whether the pay line has been already selected or not is determined. The determination is based on whether the pay line is selected or not. If it is determined that the pay line has not been selected (NO in S109), the processing returns to S101 above, and the above-described processing is repeated. On the other hand, if it is determined that the pay line has been already selected (YES in S109), the processing moves to S108 above.

As described above, the CPU 50 functions as a “defining unit” when performing S110 of the activated line selection processing program in FIG. 1.

The CPU 50 further functions as a “determining unit” when performing S103 of the activated line selection processing in FIG. 1.

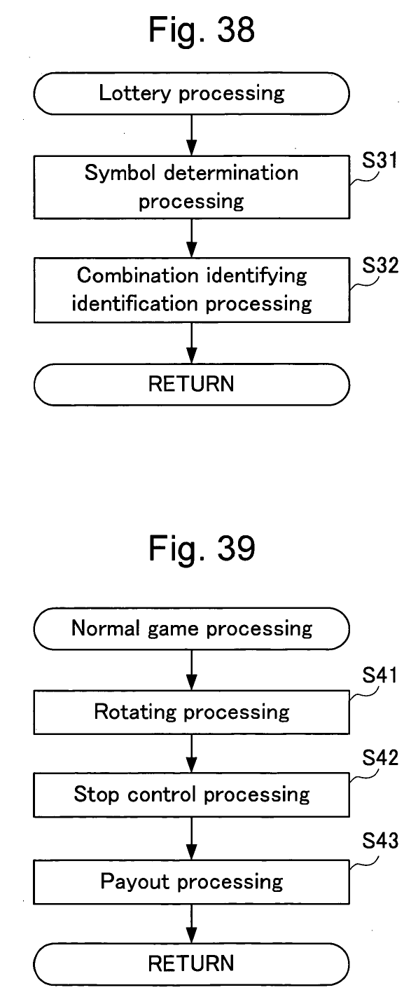

Next, the lottery processing program to be executed in the slot machine 1 will be described with reference to FIG. 38. FIG. 38 is a flowchart of the lottery processing program. In order to perform the lottery processing in S12 of the main processing program in FIG. 36, the processing first moves to S31 in FIG. 38 where symbol determination processing is performed. Here, in a normal game, a symbol to be stopped on the first pay line L1 is determined for each of the variable display windows 21 to 25. More specifically, as described above, five random number values corresponding to the variable display windows 21 to 25 are sampled by the random number sampling circuit 56, and symbols to be stopped are determined through code numbers based on the lottery table in FIG. 9. After the symbols to be stopped on the activated pay line are determined, combination identification processing is performed in S32. Then, the processing returns to the main processing program in FIG. 36 and moves to the normal game processing in S13. More specifically, in the combination determination processing, a winning combination and payout thereof are determined through the code numbers in S31 above and based on the lottery table in FIG. 8 as described above.

Next, the normal game processing program to be executed in the slot machine 1 will be described with reference to FIG. 39. FIG. 39 is a flowchart of the normal game processing program. In order to perform normal game processing in S13 of the main processing program in FIG. 36 above, the symbols in the variable display windows 21 to 25 are scrolled based on the switch signal output from the 1-LINE switch 62, 2-LINES switch 63, 5-LINES switch 64, 20-LINES switch 65 or 25-LINES switch 66, which is received in S11 in FIG. 36 above, or after the activated line selection processing in FIG. 1 above is performed in S41 in FIG. 39.

Then in S42, the symbols being scrolled in the variable display windows 21 to 25 are stopped.

Then in S43, the credit, for example, corresponding to the payout determined based on the table in FIG. 8 is paid out in accordance with the symbol arrangement of the winning combination appearing on the variable display windows 21 to 25 in S42. After the processing S43, the processing returns to the main processing program in FIG. 36 above and moves to determination processing in S14.

Next, the bonus game processing program to be executed in the slot machine 1 will be described with reference to FIG. 40. FIG. 40 is a flowchart of the bonus game processing program. In order to perform the bonus game processing in S15 in FIG. 36 if it is determined that the bonus game has been won in S14 of the main processing program in FIG. 36 above (YES in S14), the processing first moves to S51 in FIG. 40 where lottery processing during the bonus game is performed. Here, in the bonus game, a symbol to be stopped on the first pay line L1 is determined for each of the variable display windows 21 to 25. More specifically, as described above, five random number values corresponding to the variable display windows 21 to 25 are sampled by the random number sampling circuit 56, and symbols to be stopped are determined through code numbers based on the lottery table in FIG. 9. After the symbols to be stopped on the first pay line L1 are determined, a winning combination and payout thereof are determined through the code numbers and based on the table in FIG. 8.

Then in the rotating processing in S52, the symbols in the variable display windows 21 to 25 are automatically scrolled.

Then in the stop control processing in S53, the scrolling of the symbols in the variable display windows 21 to 25 in which the symbols are being scrolled is stopped.

Then in the payout processing in S54, the credit, for example, is paid out which corresponds to the payout determined in accordance with the symbol arrangement of the winning combination appearing in the variable display windows 21 to 25 in S53 and based on the table in FIG. 8 (where the “SHARK” symbol (shark) is handled as the “LOBSTER” symbol (see the lobster in FIG. 7).

Next, in S55, whether the number of executed bonus games reaches the number determined in S12 in FIG. 36 above or not is determined. If it is determined that the number of executed bonus games has not reached the number determined in S12 in FIG. 36 above (NO in S55), the processing returns to S51 where the above-described processing is repeated. On the other hand, if it is determined that the number of executed bonus games has reached the number determined in S12 in FIG. 36 above (YES in S55), the bonus game processing program is ended.

Also in S51 above, the number of repeated bonus games is newly determined if a bonus game is won. The determined number of repeated bonus games is added to the “number determined in S12 in FIG. 36 above” in the determination in S55. Thus, if a bonus game is won during a bonus game, the player can move to the bonus game again. More specifically, after 17 bonus games are won in the twelfth bonus game of 20 bonus games that the player moves to first, 25 (20−12+17) bonus games are performed.

If the player can finally get credit in the bonus games, a double down game that bets the credit is performed, the description of which will be omitted herein.

As described above, the CPU 50 functions as a “game controller” when executing the main processing program in FIG. 36.

As described above in detail, in the slot machine 1 of this embodiment, the touch panel 121 can recognize whether one of the first stop areas 211, 221, 231, 241 and 251 for display, second stop areas 212, 222, 232, 242 and 252 for display and third stop areas 213, 223, 233, 243 and 253 for display has been touched or not. A pay line can be selected by touching one of the first stop areas 211, 221, 231, 241 and 251 for display, second stop areas 212, 222, 232, 242 and 252 for display and third stop areas 213, 223, 233, 243 and 253 for display five times through the touch panel 121 (YES in S101). Thus, an activated pay line can be selected (S102 to S110). Therefore, the player can freely set any activated pay lines having any combination such that the amusement of the game may be enhanced.

The current video slot regulation can be assured if the selected pay line is set as an activated pay line (S110) through determination whether the selected pay line is activated as an activated pay line or not (YES in S103) based on the determination standard: “the pay line may not span two or more stop areas for display in the variable display windows 21 to 25.”

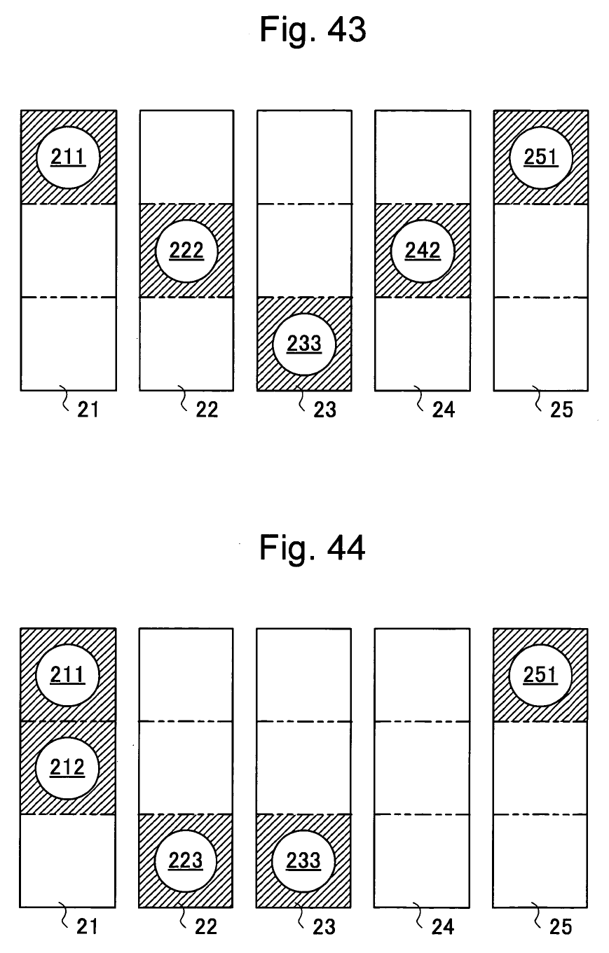

Therefore, in the slot machine 1 of this embodiment, if the RED PLAY 1 LINE button 39, PLAY 2 LINES button 40, PLAY 5 LINES button 41, PLAY 20 LINES button 42 or BLACK PLAY 25 LINES button 43 is operated (YES in S25), a predetermined combination is made activated among the pay lines L1 to L25 shown in FIGS. 11 to 35. If one of the first stop areas 211, 221, 231, 241 and 251 for display, the second stop areas 212, 222, 232, 242 and 252 for display and the third stop areas 213, 223, 233, 243 and 253 for display is touched through the touch panel 121 (YES in S24), one other than the pay lines L1 to L25 shown in FIGS. 11 to 35 can be finally made activated like the pay lines shaded in FIGS. 43 and 44, for example.

The present invention is not limited to the embodiment, but can be changed and modified variously without departing from the scope and spirit thereof.

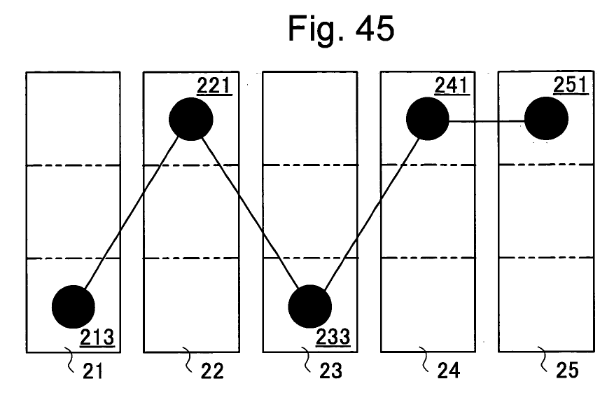

For example, in the slot machine 1 of this embodiment, when a pay line is selected in the activated line selection processing in FIG. 1, the stop area for display constituting the pay line among the first stop areas 211, 221, 231, 241 and 251 for display, second stop areas 212, 222, 232, 242 and 252 for display and third stop areas 213, 223, 233, 243 and 253 for display is inverted for a predetermined or shorter period of time only (S106). However, the present invention is not limited to the display form, but the pay line may be displayed in color or be flashed. Alternatively, as shown in FIG. 45, the pay line may be displayed like a line graph. FIG. 45 shows a sample in that one other than the pay lines L1 to L25 (the first line to twenty fifth pay line) is selected.

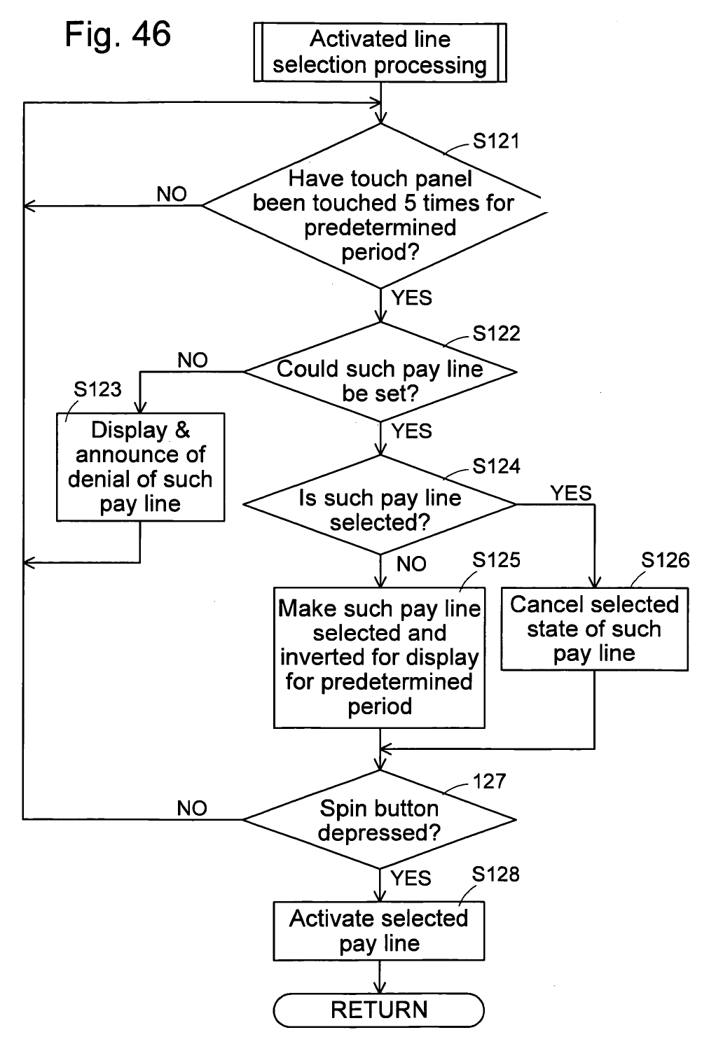

In the slot machine 1 of this embodiment, symbols in the variable display windows 21 to 25 are scrolled based on a switch signal output from the 1-LINE switch 62, 2-LINES switch 63, 5-LINES switch 64, 20-LINES switch 65 or 25-LINES switch 66, which is received in S11 in FIG. 36, or after the activated line selection processing in FIG. 1 is performed. However, a spin button may be newly provided, and the scrolling symbols in the variable display windows 21 to 25 is performed based on the pressed spin button. In this case, activated line selection processing in FIG. 46 is performed instead of the activated line selection processing in FIG. 1.

Describing the activated line selection processing in FIG. 46, whether any one of the first stop areas 211, 221, 231, 241 and 251 for display, the second stop areas 212, 222, 232, 242 and 252 for display and the third stop areas 213, 223, 233, 243 and 253 for display is touched five times within a predetermined period of time through the touch panel 121 or not is determined in S121. If it is determined that one of the first stop areas 211, 222, 232, 242 and 252 for display is touched five times through the touch panel 121 (YES in S121) here, the processing moves to S122.

Then, in S122, whether the pay line spanning the five stop areas for display touched through the touch panel 121 can be set or not is determined among the first stop areas 211, 221, 231, 241 and 251 for display, second stop areas 212, 222, 232, 242 and 252 for display and third stop areas 213, 223, 233, 243 and 253 for display. The determination may be based on the current video slot regulation that the pay line does not span two or more stop areas for display in the variable display windows 21 to 25. However, the present invention is not limited thereto if the compliance with the current video slot regulation is not required. If it is determined that the pay line cannot be set here (NO in S122), the processing moves to S123 where the fact that the pay line cannot be set is displayed on the upper liquid crystal display 3 and is output from the speaker 80. Then, the processing returns to S121, and the above-described processing is repeated. On the other hand, if it is determined that the pay line can be set (YES in S122), the processing moves to S124.

Then, in S124, whether the pay line is selected or not is determined. If it is determined that the pay line is not selected here (NO in S124), the processing moves to S125 where the pay line is selected and a stop area for display spanned by the pay line is inverted for a predetermined or shorter period of time only among the first stop areas 211, 221, 231, 241 and 251 for display, second stop areas 212, 222, 232, 242 and 252 for display and third stop areas 213, 223, 233, 243 and 253 for display. Then, the processing moves to S127.

On the other hand, if it is determined that the pay line is selected (YES in S124), the processing moves to S126 where the selection of the pay line is cancelled. Then, the processing moves to S127.

In S127, whether the spin button has been pressed or not is determined. If it is determined that the spin button has not been pressed (YES in S127), the processing returns to S121, and the above-described processing is repeated. On the other hand, if it is determined that the spin button has been pressed (NO in S127), the processing moves to S128 where all of the selected pay line or lines is or are made activated and returns to the start reception processing in FIG. 37 above. The processing further returns to the main processing program in FIG. 36 above and moves to the lottery processing in S12.

In S121 above, if is determined that none of the first stop areas 211, 221, 231, 241 and 251 for display is touched through the touch panel 121 (NO in S121), the processing returns to S121 itself where the processing waits until one of the first stop areas 211, 221, 231, 241 and 251 for display is touched by a player five times within a predetermined period of time through the touch panel 121.

The slot machine 1 of this embodiment is a video slot without a mechanical reel, but the present invention can be embodied as far as a transparent liquid crystal display including the touch panel 121 is placed on the mechanical reel even when a normal game and/or a bonus game is performed with the mechanical reel.

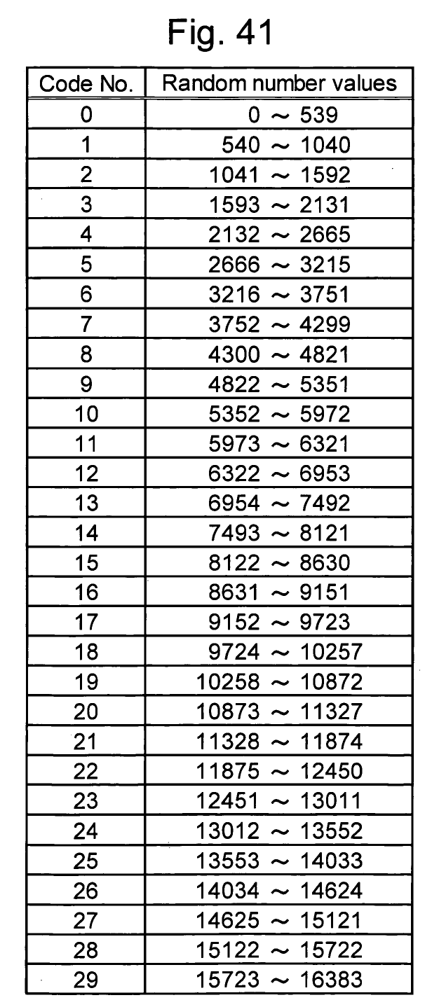

In the normal game and bonus game, the symbol to be stopped on the first pay line L1 is determined for each of the variable display windows 21 to 25 with reference to the lottery table in FIG. 9 in which one of the random number values sampled through the random number sampling circuit 56 corresponds to one of the code numbers in the slot machine 1 of this embodiment. The symbol to be stopped on the first pay line L1 may be determined for each of the variable display windows 21 to 25 with reference to the lottery table in FIG. 41 in which a specific range of the random number values sampled through the random number sampling circuit 56 corresponds to one of the code numbers, for example.

The present invention is applicable for performing a game by using a selected and activated pay line.

The gaming machine described as the embodiment of the present invention allows the player to select an activated pay line prior to spinning the reels. However, the player may alternatively select the desirable pay line even after the reels stop.

The gaming machine described as the embodiment of the present invention allows the player to form a pay line. The gaming machine may allow the player to select one or more of the stop areas so as to gain the payout such that a so-called pay line may not have to be formed.

While the embodiment has been described with selecting pay lines by a player, the present invention is applicable to the gaming machine that does not require a pay line. For instance, the gaming machine may provide payout not only based on the symbol arrangement on a pay line, but also based on the symbol arrangement shown on the stop areas. After a player select at least one stop area by the selectign button, the player can be awarded with the payout because the symbols shown on the stop area meets a winning combination.

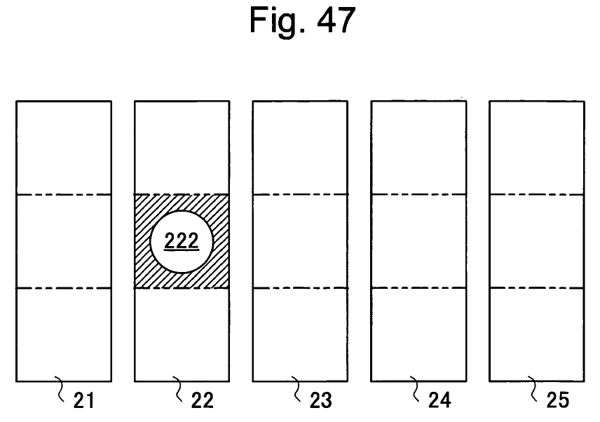

In reference to FIG. 47, by way of example, a symbol in a shaded stop display area 222 is shown in the window 22. The symbol shown on the stop display area 222 may be a so-called “scatter symbol” that becomes activated and provides a payout without any pay lines. Two or more of the symbols may be shown on the display windows 21-25 in a connected manner (for a pay line) or in a scattered manner (for scatter symbols).

1. A gaming machine having a display device and game control means for providing a payout based on a symbol arrangement on said display device, the gaming machine comprising:
a plurality of stop areas for display, on which a plurality of symbols are variably displayed and stopped to form said symbol arrangement, said symbol arrangement comprising at least one symbol appearing in an area arrangement being composed of at least one of said plurality of stop areas;
a plurality of selection buttons corresponding to said plurality of stop areas, respectively;
determination means for determining whether said area arrangement having been identified via said plurality of selection buttons can be activated or not; and
setting means for setting said area arrangement being activated.

2. The gaming machine according to claim 1, wherein said game control means provides a payout based on at least one appearing symbol in at least one of said plurality of stop areas regardless of said area arrangement.

3. The gaming machine according to claim 1, wherein said display device comprises a touch panel that identifies said area arrangement therethrough.

4. The gaming machine according to claim 1, wherein said area arrangement comprises a pay line.

5. A gaming machine comprising:
a cabinet;
a display device provided on a front face of the cabinet;
a plurality of selection buttons provided on the cabinet; and
a game controller provided inside the cabinet for controlling a game,
wherein the display device comprises a plurality of stop areas for variably displaying symbols, said plurality of stop area can be identified by said plurality of selection buttons, respectively, and a symbol arrangement comprises at least one symbol being stopped and appearing in at least one of said plurality of stop areas such that said symbol arrangement corresponds to an area arrangement being composed of the at least one of said plurality of stop areas; and
wherein said game controller controls the game such that the gaming machine provides a payout based on said symbol arrangement appearing in said area arrangement after determining whether said area arrangement having been located via said plurality of selection buttons can be activated or not.

6. The gaming machine according to claim 5, wherein said game controller controls the gaming machine so as to provide a payout based on at least one appearing symbol in at least one of said plurality of stop areas regardless of said area arrangement.

7. The gaming machine according to claim 5, wherein said display device comprises a touch panel such that said area arrangement is identified therethrough.

8. The gaming machine according to claim 5, wherein said area arrangement comprises a pay line.

9. A method of controlling a game with a gaming machine which comprises:
a cabinet forming a general shape of the gaming machine;
a display device provided on a front face of the cabinet;
a plurality of selection buttons provided on the cabinet; and
a game controller provided inside the cabinet for controlling a game,
wherein the display device comprises a plurality of stop areas for variably displaying symbols, said plurality of stop area can be identified by said plurality of selection buttons, respectively, and a symbol arrangement comprises at least one symbol being stopped and appearing in at least one of said plurality of stop areas such that said symbol arrangement corresponds to an area arrangement being composed of the at least one of said plurality of stop areas;
wherein said game controller controls the game such that the gaming machine provides a payout based on said symbol arrangement appearing in said area arrangement after determining whether said area arrangement having been located via said plurality of selection buttons can be activated or not; and
wherein said game controller controls the gaming machine so as to provide a payout based on at least one appearing symbol in at least one of said plurality of stop areas regardless of said area arrangement, the gaming method comprising:
making a player select said area arrangement;
starting a lottery;
determining if a bonus game is won; and
starting a bonus game when the bonus game is won.
